(19) United States
(12) Patent Application Publication
(10) Pub. No.: US 2026/0278041 A1
(43) Pub. Date: Sep. 17, 2026

(54) DATA PROCESSING METHOD AND APPARATUS, DEVICE, AND READABLE STORAGE MEDIUM

(71) Applicant: Tencent Technology (Shenzhen) Company Limited, Shenzhen (CN)

(72) Inventors: Wei LIU, Shenzhen (CN); Jie JIANG, Shenzhen (CN); Yao DING, Shenzhen (CN); Guinan SU, Shenzhen (CN); Zongwei LI, Shenzhen (CN); Yeting HE, Shenzhen (CN); Zhipeng YANG, Shenzhen (CN); Sirui GAO, Shenzhen (CN)

(73) Assignee: Tencent Technology (Shenzhen) Company Limited, Shenzhen, GD (CN)

(21) Appl. No.: 19/664,464

(22) Filed: Apr. 30, 2026

Related U.S. Application Data
(63) Continuation of application No. PCT/CN2024/136156, filed on Dec. 2, 2024.

(30) Foreign Application Priority Data
Jan. 5, 2024 (CN) 202410024726.2

(51) Int. Cl. G06F 18/214; G06F 18/213; G06F 40/211; G06F 40/30

(52) U.S. Cl. CPC G06F 18/214; G06F 18/213; G06F 40/211; G06F 40/30

(57) ABSTRACT

The present disclosure discloses a method includes: performing category division on M question-answer pair data based on a question-answer pair category information set, to obtain category labels respectively corresponding to the M question-answer pair data; generating N training sample sets and sample set category labels respectively corresponding to the N training sample sets based on the M question-answer pair data and the category labels respectively corresponding to the M question-answer pair data; sorting the N training sample sets according to learning difficulties corresponding to the sample set category labels, to obtain a training sample sequence; and sequentially obtaining input training samples in the training sample sequence, and sequentially adjusting model parameters of an initial question-answer model by using the sequentially obtained input training samples until the initial question-answer model converges in training to obtain a target question-answer model.

### RELATED APPLICATION

This application is a continuation of and claims the benefit of priority to PCT Application No. PCT/CN2024/136156, filed Dec. 2, 2024, and entitled DATA PROCESSING METHOD AND APPARATUS, AND DEVICE AND READABLE STORAGE MEDIUM, which is based on and claims priority to Chinese Patent Application No. 202410024726.2, filed with the China National Intellectual Property Administration on Jan. 5, 2024 and entitled “DATA PROCESSING METHOD AND APPARATUS, DEVICE, AND READABLE STORAGE MEDIUM.” The above applications are incorporated herein by reference in their entireties.

### FIELD OF THE TECHNOLOGY

The present disclosure relates to the field of computer technologies, and in particular, to a data processing method and apparatus, a device, and a readable storage medium.

### BACKGROUND OF THE DISCLOSURE

During a supervised fine-tuning stage of an existing large language model (LLM), a massive number of samples is first obtained. These samples include both simple and complex samples. When the model does not possess a particular level of comprehension capability, directly adjusting model parameters using the complex samples will cause the model to over-adjust the parameters to fit the complex samples. As a result, the model fails to learn the features of the simple samples, making it unable to apply to simple or normal samples. To be specific, model training is suboptimal, thereby reducing model accuracy and affecting the generation capability of the model.

### SUMMARY

Embodiments of the present disclosure provide a data processing method an apparatus, a device, and a readable storage medium, to improve the model accuracy of a target question-answer model.

An aspect of embodiments of the present disclosure provides a data processing method, including:
obtaining M question-answer pair data and a question-answer pair category information set, and performing category division on the M question-answer pair data based on the question-answer pair category information set, to obtain category labels respectively corresponding to the M question-answer pair data, the question-answer pair category information set including the category labels, and M being a positive integer;
generating N training sample sets and sample set category labels respectively corresponding to the N training sample sets based on the M question-answer pair data and the category labels respectively corresponding to the M question-answer pair data, N being a positive integer, and input training samples in each training sample set being all associated with at least one piece of question-answer pair data among the M question-answer pair data;
sorting the N training sample sets according to learning difficulties corresponding to the sample set category labels, to obtain a training sample sequence, the learning difficulty referring to a difficulty for an initial question-answer model to train and learn the input training samples having the sample set category labels; and
sequentially obtaining, in the training sample sequence, input training samples from the sorted training sample sets, and sequentially adjusting model parameters of the initial question-answer model by using the sequentially obtained input training samples until the initial question-answer model converges in training to obtain a target question-answer model, the target question-answer model being configured to generate a question-answer service result via a service question.

The performing category division on the M question-answer pair data based on the question-answer pair category information set, to obtain category labels respectively corresponding to the M question-answer pair data includes:
inputting the M question-answer pair data and the question-answer pair category information set into a sample division model, generating a keyword vector based on the question-answer pair category information set in the sample division model, and performing feature extraction on the M question-answer pair data, to obtain feature word vectors respectively corresponding to the M question-answer pair data; and
determining the category labels respectively corresponding to the M question-answer pair data based on the feature word vectors and the keyword vector.

The performing feature extraction on the M question-answer pair data, to obtain feature word vectors respectively corresponding to the M question-answer pair data includes:
filtering service stop words from the M question-answer pair data, and performing text division on the filtered M question-answer pair data, to obtain P question-answer text segments, P being a positive integer greater than or equal to M; and
performing part-of-speech tagging on the P question-answer text segments respectively, to obtain P question-answer part-of-speech information, and generating the feature word vectors respectively corresponding to the M question-answer pair data based on the P question-answer text segments and the P question-answer part-of-speech information.

The N training sample sets include a first-stage training sample set, a second-stage training sample set, and a third-stage training sample set.

The generating N training sample sets and sample set category labels respectively corresponding to the N training sample sets based on the M question-answer pair data and the category labels respectively corresponding to the M question-answer pair data includes:
obtaining basic question-answer pair data from the M question-answer pair data, dividing the basic question-answer pair data into the first-stage training sample set, and determining the category label corresponding to the basic question-answer pair data as a sample set category label corresponding to the first-stage training sample set;
obtaining progressive question-answer pair data from the M question-answer pair data, determining the progressive question-answer pair data as the second-stage training sample set, generating a progressive chain-of-thought sample category label, and determining the progressive chain-of-thought sample category label as a sample set category label corresponding to the second-stage training sample set, the learning difficulty corresponding to the progressive chain-of-thought sample category label being greater than the learning difficulty corresponding to the category label of the basic question-answer pair data; and
obtaining first multi-turn question-answer pair data from the M question-answer pair data, generating second multi-turn question-answer pair data according to the basic question-answer pair data, determining the first multi-turn question-answer pair data and the second multi-turn question-answer pair data as the third-stage training sample set, generating a multi-turn category label, and determining the multi-turn category label as a sample set category label corresponding to the third-stage training sample set, the learning difficulty corresponding to the multi-turn category label being greater than the learning difficulty corresponding to the progressive chain-of-thought sample category label.

The number of the basic question-answer pair data is H, H being a positive integer less than or equal to M. The first-stage training sample set further includes a short dialog training sample set. The method further includes:
obtaining context information corresponding to H basic question-answer pair data, the context information being configured for indicating a semantic degree of association among the H basic question-answer pair data;
splicing S mutually associated basic question-answer pair data into a short dialog training sample according to the context information, adding the short dialog training sample to the short dialog training sample set, and determining a short dialog label as a sample set category label corresponding to the short dialog training sample set, S being a positive integer less than or equal to H.

The generating second multi-turn question-answer pair data according to the basic question-answer pair data includes:
splicing the basic question-answer pair data to obtain spliced multi-turn question-answer pair data;
performing data reconstruction on the basic question-answer pair data to obtain reconstructed multi-turn question-answer pair data; and
determining the spliced multi-turn question-answer pair data and the reconstructed multi-turn question-answer pair data as the second multi-turn question-answer pair data.

The number of the basic question-answer pair data is H, H being a positive integer less than or equal to M. The splicing the basic question-answer pair data to obtain spliced multi-turn question-answer pair data includes:
obtaining context information corresponding to H basic question-answer pair data, the context information being configured for indicating a semantic degree of association among the H basic question-answer pair data;
obtaining Q basic question-answer pair data according to the context information, and splicing the Q basic question-answer pair data into follow-up dialog data, Q being a positive integer less than or equal to H, and a semantic degree of association among the Q basic question-answer pair data being greater than a first degree-of-association threshold;
obtaining T basic question-answer pair data according to the context information, and splicing the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and
determining the follow-up dialog data and the random dialog data as the spliced multi-turn question-answer pair data.

The number of the basic question-answer pair data is H, H being a positive integer less than or equal to M. The performing data reconstruction on the basic question-answer pair data to obtain reconstructed multi-turn question-answer pair data includes:
rewriting, based on evolution constraint information, the basic question-answer pair data into deep evolution data, the evolution constraint information being configured for indicating evolution category labels included in the question-answer pair category information set, and the deep evolution data being associated with the evolution category labels;
obtaining context information corresponding to H basic question-answer pair data, and rewriting mutually associated basic question-answer pair data into breadth evolution data according to the context information, the context information being configured for indicating a semantic degree of association among the H basic question-answer pair data; and
determining the deep evolution data and the breadth evolution data as the reconstructed multi-turn question-answer pair data.

The rewriting, based on evolution constraint information, the basic question-answer pair data into deep evolution data includes:
rewriting, based on the evolution constraint information, the basic question-answer pair data into transitional evolution data; and
continuing to perform, if the number of question-answer turns of the transitional evolution data is less than a question-answer turn threshold, data rewriting on the transitional evolution data based on the evolution constraint information until the number of question-answer turns of the rewritten transitional evolution data is greater than or equal to the question-answer turn threshold, to determine the rewritten transitional evolution data as the deep evolution data.

The training sample sequence includes a training sample set Aᵢ and a training sample set Aᵢ₊₁, the training sample set Aᵢ preceding the training sample set Aᵢ₊₁ in the training sample sequence.

The sequentially obtaining, in the training sample sequence, input training samples from the sorted training sample sets, and sequentially adjusting model parameters of the initial question-answer model by using the sequentially obtained input training samples until the initial question-answer model converges in training to obtain a target question-answer model includes:
randomly obtaining, in a j^{th} iterative training, B first input training samples from the training sample set Aᵢ, adjusting the model parameters of the initial question-answer model by using the B first input training samples, continuing to randomly obtain C second input training samples from the training sample set Aᵢ₊₁, and adjusting the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed, B and C being positive integers, and j being a positive integer;
determining, if the j^{th} iterative training is completed and the initial question-answer model satisfies a model convergence condition, the initial question-answer model satisfying the model convergence condition as the target question-answer model; and
if the j^{th} iterative training is completed and the initial question-answer model does not satisfy the model convergence condition, continuing to sequentially adjust, in a (j+1)^{th} iterative training, the model parameters of the initial question-answer model by using sequentially obtained input training samples via the training sample sequence until the initial question-answer model converges in training to obtain the target question-answer model.

An aspect of embodiments of the present disclosure provides a data processing apparatus, including:
a category division module, configured to obtain M question-answer pair data and a question-answer pair category information set, and perform category division on the M question-answer pair data based on the question-answer pair category information set, to obtain category labels respectively corresponding to the M question-answer pair data, the question-answer pair category information set including the category labels, and M being a positive integer;
a sample generation module, configured to generate N training sample sets and sample set category labels respectively corresponding to the N training sample sets based on the M question-answer pair data and the category labels respectively corresponding to the M question-answer pair data, N being a positive integer, and input training samples in each training sample set being all associated with at least one piece of question-answer pair data among the M question-answer pair data;
a sorting processing module, configured to sort the N training sample sets according to learning difficulties corresponding to the sample set category labels, to obtain a training sample sequence, the learning difficulty referring to a difficulty for an initial question-answer model to train and learn the input training samples having the sample set category labels; and
a model training module, configured to sequentially obtain, in the training sample sequence, input training samples from the sorted training sample sets, and sequentially adjust model parameters of the initial question-answer model by using the sequentially obtained input training samples, until a target question-answer model is obtained after the initial question-answer model converges in training, the target question-answer model being configured to generate a question-answer service result via a service question.

In a possible implementation, when performing category division on the M question-answer pair data based on the question-answer pair category information set, to obtain category labels respectively corresponding to the M question-answer pair data, the category division module is specifically configured to perform the following operations:
inputting the M question-answer pair data and the question-answer pair category information set into a sample division model, generating a keyword vector based on the question-answer pair category information set in the sample division model, and performing feature extraction on the M question-answer pair data, to obtain feature word vectors respectively corresponding to the M question-answer pair data; and
determining the category labels respectively corresponding to the M question-answer pair data based on the feature word vectors and the keyword vector.

In a possible implementation, when performing feature extraction on the M question-answer pair data, to obtain feature word vectors respectively corresponding to the M question-answer pair data, the category division module is specifically configured to perform the following operations:
filtering service stop words from the M question-answer pair data, and performing text division on the filtered M question-answer pair data, to obtain P question-answer text segments, P being a positive integer greater than or equal to M; and
performing part-of-speech tagging on the P question-answer text segments respectively, to obtain P question-answer part-of-speech information, and generating the feature word vectors respectively corresponding to the M question-answer pair data based on the P question-answer text segments and the P question-answer part-of-speech information.

In a possible implementation, N training sample sets include a first-stage training sample set, a second-stage training sample set, and a third-stage training sample set. When generating N training sample sets and sample set category labels respectively corresponding to the N training sample sets based on the M question-answer pair data and the category labels respectively corresponding to the M question-answer pair data, the sample generation module is specifically configured to perform the following operations:
obtaining basic question-answer pair data from the M question-answer pair data, dividing the basic question-answer pair data into the first-stage training sample set, and determining the category label corresponding to the basic question-answer pair data as a sample set category label corresponding to the first-stage training sample set;
obtaining progressive question-answer pair data from the M question-answer pair data, determining the progressive question-answer pair data as the second-stage training sample set, generating a progressive chain-of-thought sample category label, and determining the progressive chain-of-thought sample category label as a sample set category label corresponding to the second-stage training sample set, the learning difficulty corresponding to the progressive chain-of-thought sample category label being greater than the learning difficulty corresponding to the category label of the basic question-answer pair data; and
obtaining first multi-turn question-answer pair data from the M question-answer pair data, generating second multi-turn question-answer pair data according to the basic question-answer pair data, determining the first multi-turn question-answer pair data and the second multi-turn question-answer pair data as the third-stage training sample set, generating a multi-turn category label, and determining the multi-turn category label as a sample set category label corresponding to the third-stage training sample set, the learning difficulty corresponding to the multi-turn category label being greater than the learning difficulty corresponding to the progressive chain-of-thought sample category label.

In a possible implementation, the number of the basic question-answer pair data is H, H being a positive integer less than or equal to M. The first-stage training sample set further includes a short dialog training sample set. The sample generation module is further configured to perform the following operations:
obtaining context information corresponding to H basic question-answer pair data, the context information being configured for indicating a semantic degree of association among the H basic question-answer pair data;
splicing S mutually associated basic question-answer pair data into a short dialog training sample according to the context information, adding the short dialog training sample to the short dialog training sample set, and determining a short dialog label as a sample set category label corresponding to the short dialog training sample set, S being a positive integer less than or equal to H.

In a possible implementation, when generating second multi-turn question-answer pair data according to the basic question-answer pair data, the sample generation module is specifically configured to perform the following operations:
splicing the basic question-answer pair data to obtain spliced multi-turn question-answer pair data;
performing data reconstruction on the basic question-answer pair data to obtain reconstructed multi-turn question-answer pair data; and
determining the spliced multi-turn question-answer pair data and the reconstructed multi-turn question-answer pair data as the second multi-turn question-answer pair data.

In a possible implementation, the number of the basic question-answer pair data is H, H being a positive integer less than or equal to M. When splicing the basic question-answer pair data to obtain spliced multi-turn question-answer pair data, the sample generation module is specifically configured to perform the following operations:
obtaining context information corresponding to H basic question-answer pair data, the context information being configured for indicating a semantic degree of association among the H basic question-answer pair data;
obtaining Q basic question-answer pair data according to the context information, and splicing the Q basic question-answer pair data into follow-up dialog data, Q being a positive integer less than or equal to H, and a semantic degree of association among the Q basic question-answer pair data being greater than a first degree-of-association threshold;
obtaining T basic question-answer pair data according to the context information, and splicing the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and
determining the follow-up dialog data and the random dialog data as the spliced multi-turn question-answer pair data.

In a possible implementation, the number of the basic question-answer pair data is H, H being a positive integer less than or equal to M. When performing data reconstruction on the basic question-answer pair data to obtain reconstructed multi-turn question-answer pair data, the sample generation module is specifically configured to perform the following operations:
rewriting, based on evolution constraint information, the basic question-answer pair data into deep evolution data, the evolution constraint information being configured for indicating evolution category labels included in the question-answer pair category information set, and the deep evolution data being associated with the evolution category labels;
obtaining context information corresponding to H basic question-answer pair data, and rewriting mutually associated basic question-answer pair data into breadth evolution data according to the context information, the context information being configured for indicating a semantic degree of association among the H basic question-answer pair data; and
determining the deep evolution data and the breadth evolution data as the reconstructed multi-turn question-answer pair data.

In a possible implementation, when rewriting, based on evolution constraint information, the basic question-answer pair data into deep evolution data, the sample generation module is specifically configured to perform the following operations:
rewriting, based on the evolution constraint information, the basic question-answer pair data into transitional evolution data; and
continuing to perform, if the number of question-answer turns of the transitional evolution data is less than a question-answer turn threshold, data rewriting on the transitional evolution data based on the evolution constraint information until the number of question-answer turns of the rewritten transitional evolution data is greater than or equal to the question-answer turn threshold, to determine the rewritten transitional evolution data as the deep evolution data.

In a possible implementation, The training sample sequence includes a training sample set Aᵢ and a training sample set Aᵢ₊₁, the training sample set Aᵢ preceding the training sample set Aᵢ₊₁ in the training sample sequence. When sequentially obtaining, in the training sample sequence, input training samples from the sorted training sample sets, and sequentially adjusting model parameters of the initial question-answer model by using the sequentially obtained input training samples until the initial question-answer model converges in training to obtain a target question-answer model, the model training module is specifically configured to perform the following operations:
randomly obtaining, in a j^{th} iterative training, B first input training samples from the training sample set Aᵢ, adjusting the model parameters of the initial question-answer model by using the B first input training samples, continuing to randomly obtain C second input training samples from the training sample set Aᵢ₊₁, and adjusting the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed, B and C being positive integers, and j being a positive integer;
determining, if the j^{th} iterative training is completed and the initial question-answer model satisfies a model convergence condition, the initial question-answer model satisfying the model convergence condition as the target question-answer model; and
if the j^{th} iterative training is completed and the initial question-answer model does not satisfy the model convergence condition, continuing to sequentially adjust, in a (j+1)^{th} iterative training, the model parameters of the initial question-answer model by using sequentially obtained input training samples via the training sample sequence until the initial question-answer model converges in training to obtain the target question-answer model.

An aspect of embodiments of the present disclosure provides a computer device, including: a processor, a memory, and a network interface.

The processor is connected to the memory and the network interface, the network interface being configured to provide a data communication function, the memory being configured to store a computer program, and the computer program, when executed by the processor, enabling the computer device to perform the method provided by the embodiments of the present disclosure.

An aspect of embodiments of the present disclosure provides a computer-readable storage medium. The computer-readable storage medium has a computer program stored therein, the computer program being adapted to be loaded and executed by a processor, to enable a computer device including the processor to perform the method provided by the embodiments of the present disclosure.

An aspect of embodiments of the present disclosure provides a computer program product. The computer program product includes a computer program, the computer program being stored in a computer-readable storage medium. A processor of a computer device reads the computer program from the computer-readable storage medium. The processor executes the computer program, to enable the computer device to perform the method provided by the embodiments of the present disclosure.

In the embodiments of the present disclosure, category division is performed on question-answer pair data through a question-answer pair category information set, to obtain category labels corresponding to the respective question-answer pair data. Then training sample sets and sample set category labels respectively corresponding to the training sample sets are generated through the question-answer pair data and the category labels respectively corresponding to the question-answer pair data. By sorting the training sample sets according to learning difficulties, the model may first learn features of the training sample sets with lower difficulty during training, and then continue training through the training sample sets with higher difficulty, to gradually help the model learn complex features, thereby avoiding over-fitting on high-difficulty training samples, generalizing more complex and diverse question-answer scenarios, and improving the accuracy of the trained model.

### BRIEF DESCRIPTION OF THE DRAWINGS

To describe the technical solutions of embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other accompanying drawings from these accompanying drawings without creative efforts.

FIG. 1 is an example schematic structural diagram of a blockchain network according to an embodiment of the present disclosure;

FIG. 2 is an example schematic diagram 1 of a data processing scenario according to an embodiment of the present disclosure;

FIG. 3 is an example schematic flowchart 1 of a data processing method according to an embodiment of the present disclosure;

FIG. 4a is an example schematic flowchart 2 of a data processing method according to an embodiment of the present disclosure;

FIG. 4b is an example schematic diagram 2 of a data processing scenario according to an embodiment of the present disclosure;

FIG. 5 is an example schematic structural diagram of a data processing apparatus according to an embodiment of the present disclosure; and

FIG. 6 is an example schematic structural diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

Artificial intelligence (AI) is a theory, a method, a technology, and an application system that use a digital computer or a machine controlled by the digital computer to simulate, extend, and expand human intelligence, perceive an environment, obtain knowledge, and use the knowledge to obtain an optimal result. In other words, AI is a comprehensive technology in computer science, and attempts to understand essence of intelligence and produce a new intelligent machine that can react in a manner similar to human intelligence. AI is to research design principles and implementation methods of various intelligent machines, so that the machines have functions of perception, reasoning, and decision-making.

The AI technology is a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions, such as computer vision (CV), a speech processing technology, a natural language processing technology, and machine learning (ML)/deep learning (DL).

CV is a field of science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. CV may generally include technologies such as image processing, image recognition, image semantic understanding, image retrieval, video processing, video semantic understanding, video content/behavior recognition, three-dimensional object reconstruction, virtual reality, augmented reality, synchronous positioning and map construction, autonomous driving, and intelligent traffic.

ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to acquire new knowledge or skills, and reorganize an existing knowledge structure, so as to keep improving its performance. ML is a core of AI, is a fundamental way to make a computer intelligent, and is applied in various fields of AI. ML and DL generally include technologies such as an artificial neural network, a confidence network, reinforcement learning, transfer learning, inductive learning, and tutorial learning.

DL is to learn an internal law and a representation level of sample data, and the information obtained during the learning is of great help to interpretation of data such as a text, an image, and a sound. An ultimate objective of DL is to enable a machine to have analysis and learning capabilities the same as those of a human being, and to recognize the data such as a text, an image, and a voice. DL is a complex ML algorithm, and has effects in speech and image recognition that far exceed the previous related art.

The solutions provided in the embodiments of the present disclosure relate to technologies such as AI DL. Specifically, the solutions are described by using the following embodiments.

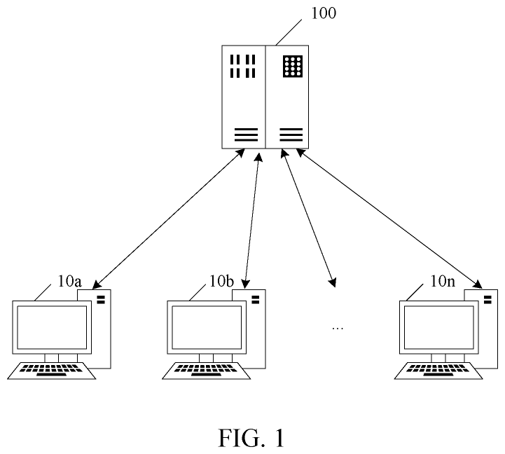

Refer to FIG. 1. FIG. 1 is a schematic diagram of a network architecture according to an embodiment of the present disclosure. As shown in FIG. 1, the network architecture may include a service server 100 and a terminal device cluster. The terminal device cluster may include terminal device 10a, terminal device 10b, . . . , terminal device 10n. Any terminal device in the terminal device cluster may have a communication connection with the service server 100. For example, there is a communication connection between terminal device 10a and the service server 100, and a communication connection between terminal device 10b and the service server 100. The foregoing communication connection does not limit a connection mode. The connection may be direct or indirect through wired communication, direct or indirect through wireless communication, or other modes. This is not limited in the present disclosure herein.

Specifically, each terminal device in the terminal cluster shown in FIG. 1 may transmit a category division request to the service server 100. The category division request may include question-answer pair data and a question-answer pair category information set.

The question-answer pair data may be text data for training an LLM, including a series of questions and corresponding answers. The question-answer pair data may be obtained by manual annotation or automatic extraction, and may cover different domains and topics.

The question-answer pair category information set may be an information set for annotating the question-answer pair data, and may include a plurality of category labels. The category labels may be divided according to dimensions such as learning difficulties of questions and answers, domains and topics of questions, answer types, and lengths.

Taking terminal device 10a as an example, the service server 100 may obtain a category division request transmitted by terminal device 10a, and perform category division on question-answer pair data and a question-answer pair category information set in the category division request through a sample division model in the service server 100, so as to obtain category labels corresponding to the question-answer pair data. These category labels belong to the question-answer pair category information set. The sample division model may be a converged LLM, which may take the question-answer pair category information set as a text prompt for the question-answer pair data, and perform category division on the question-answer pair data to obtain the corresponding category labels.

The service server 100 may generate training sample sets and sample category labels corresponding to the training sample sets respectively through the question-answer pair data and the category labels corresponding to the question-answer pair data, and sort the training sample sets according to learning difficulties corresponding to the sample set category labels to obtain a training sample sequence.

By sorting the training sample sets according to the learning difficulties, the model may learn features of training samples with lower difficulty during training, and then perform training through the training samples with higher difficulty, to gradually help the model learn complex features, thereby achieving the same accuracy as using the entire training sample sequence, avoiding over-fitting on high-difficulty training samples, generalizing more complex and diverse question-answer scenarios, and improving the efficiency of model training and the accuracy of the model.

The service server 100 may transmit the training sample sequence to terminal device 10a. Terminal device 10a may sequentially obtain, in the training sample sequence, input training samples from the sorted training sample sets, and sequentially adjust model parameters of the initial question-answer model by using the sequentially obtained input training samples until the initial question-answer model in terminal device 10a converges in training to obtain a target question-answer model. The target question-answer model may be configured to generate question-answer service results from service questions.

The service server 100 and terminal device 10a may alternatively be integrated into one server, which may be referred to as a model server, for example.

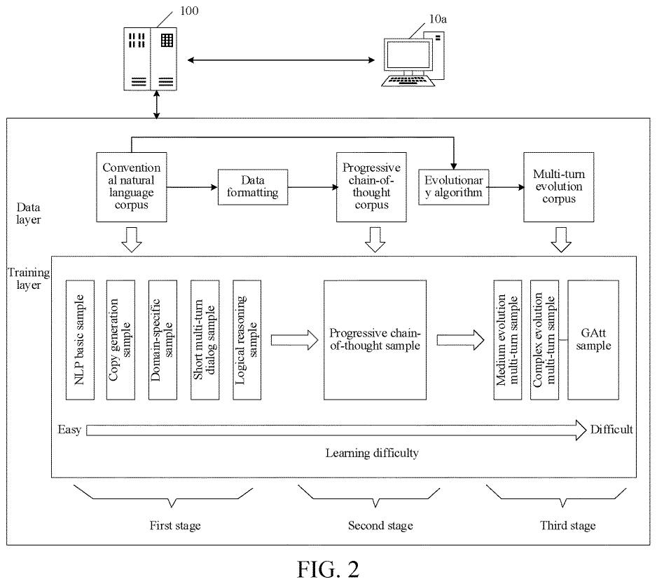

Refer to FIG. 2. FIG. 2 is a schematic diagram 1 of a data processing scenario according to an embodiment of the present disclosure. As shown in FIG. 2, terminal device 10a may transmit a category division request to the service server 100. The category division request may include question-answer pair data and a question-answer pair category information set.

The question-answer pair data may be text data for training a large language model, including a series of questions and corresponding answers. The question-answer pair data may be obtained by manual annotation or automatic extraction, and may cover different domains and topics.

The question-answer pair category information set may be an information set for annotating the question-answer pair data, and may include a plurality of category labels. The category labels may be divided according to dimensions such as learning difficulties of questions and answers, domains and topics of questions, answer types, and lengths.

Taking terminal device 10a as an example, the service server 100 may obtain a category division request transmitted by terminal device 10a, and perform category division on question-answer pair data and a question-answer pair category information set in the category division request through a sample division model in the service server 100, so as to obtain category labels corresponding to the question-answer pair data.

The sample division model in the service server 100 may take the question-answer pair category information set as a text prompt for the question-answer pair data, and perform category classification on the question-answer pair data. The classification operations may be: “The following is a category system: question-answer pair category information set. Please classify the following text “{question-answer pair data 1, question-answer pair data 2, . . . , question-answer pair data N}” into the most associated category label in the above question-answer pair category information set, and output a result to result in the following structure {“category”: result}”. The organization form of “result” may be {“question-answer pair data 1”: natural language processing (NLP) basic category label, “question-answer pair data 2”: copy generation category label, . . . , “question-answer pair data N”: multi-turn dialog category label}.

The service server 100 may obtain basic question-answer pair data (also referred to as a conventional natural language corpus) from the question-answer pair data, and divide the basic question-answer pair data into a first-stage training sample set (the basic question-answer pair data may include NLP basic question-answer pair data, copy generation question-answer pair data, domain-specific question-answer pair data, short multi-turn dialog data, and logical reasoning question-answer pair data).

The NLP basic question-answer pair data may be conventional dialogs such as translation tasks, text summarization, text rewriting, and part-of-speech tagging. The NLP basic question-answer pair data focuses on covering text data in which results may be judged with objective measurement metrics. The text data of the copy generation question-answer pair data may be generation-type dialogs including comment writing, press release writing, brainstorming, and the like. The copy generation question-answer pair data is configured for covering open-ended text data (the quality of answers may vary with different evaluators). The domain-specific question-answer pair data may be dialogs involving keywords in various professional domains such as law, medicine, and physics. The short multi-turn dialog data may be question-answer pair data with a plurality of question-answer turns. The logical reasoning question-answer pair data may be reasoning-type dialogs such as sorting and comparison, comprehensive analysis, and paradox problems.

The category labels of the basic question-answer pair data may include NLP basic category labels (corresponding to the NLP basic question-answer pair data in the question-answer pair data, i.e., NLP basic samples shown in FIG. 2), copy generation category labels (corresponding to the copy generation question-answer pair data in the question-answer pair data, i.e., copy generation samples shown in FIG. 2), domain-specific category labels (corresponding to the domain-specific question-answer pair data in the question-answer pair data, i.e., domain-specific samples shown in FIG. 2), and logical reasoning category labels (corresponding to the logical reasoning question-answer pair data in the question-answer pair data, i.e., logical reasoning samples shown in FIG. 2). The service server 100 may generate sample set category labels corresponding to the first-stage training sample set. For example, the first-stage training sample set may include a training sample set composed of NLP basic question-answer pair data, a training sample set composed of copy generation question-answer pair data, a training sample set composed of domain-specific question-answer pair data, and a training sample set composed of logical reasoning question-answer pair data. The sample set category labels corresponding to the first-stage training sample set may include NLP basic sample set category labels corresponding to the training sample set composed of NLP basic question-answer pair data, copy generation sample set category labels corresponding to the training sample set composed of copy generation question-answer pair data, domain-specific sample set category labels corresponding to the training sample set composed of domain-specific question-answer pair data, and logical reasoning sample set category labels corresponding to the training sample set composed of logical reasoning question-answer pair data.

The service server 100 obtains progressive question-answer pair data (also referred to as a progressive chain-of-thought corpus) from the basic question-answer pair data. For example, the progressive question-answer pair data may be obtained by gradually decomposing answer operations in the basic question-answer pair data into a plurality of operation turns. The progressive question-answer pair data is determined as a second-stage training sample set (which may include progressive chain-of-thought samples), and progressive chain-of-thought sample category labels are generated. The progressive chain-of-thought sample category labels are determined as sample set category labels corresponding to the second-stage training sample set. For example, progressive chain-of-thought sample set category labels may be determined as the sample set category labels corresponding to the progressive chain-of-thought samples.

The service server 100 may obtain first multi-turn question-answer pair data from the question-answer pair data (e.g., question-answer pair data in the form of original multi-turn dialog). The service server 100 may perform data processing on the basic question-answer pair data through an evolutionary algorithm (which may be data splicing and data rewriting of the basic question-answer pair data) to obtain second multi-turn question-answer pair data (also referred to as a multi-turn evolutionary corpus). The service server 100 may determine the first multi-turn question-answer pair data and the second multi-turn question-answer pair data as a third-stage training sample set. In addition, multi-turn category labels may be generated, and the multi-turn category labels are determined as sample set category labels corresponding to the third-stage training sample set, for example, evolutionary multi-turn sample set category labels (corresponding to medium evolutionary multi-turn samples shown in FIG. 2), complex evolutionary multi-turn sample set category labels (corresponding to complex evolutionary multi-turn samples shown in FIG. 2), and GAtt sample set category labels (corresponding to GAtt samples shown in FIG. 2).

The service server 100 may sort the training sample sets according to the learning difficulty corresponding to the sample set category labels, so as to obtain a sorted training sample sequence. The training sample sets in the training sample sequence are arranged in ascending order of learning difficulties.

The service server 100 may transmit the training sample sequence to terminal device 10a. Terminal device 10a may sequentially obtain, in the training sample sequence, input training samples from the sorted training sample sets, and sequentially adjust model parameters of the initial question-answer model by using the sequentially obtained input training samples until the initial question-answer model in terminal device 10a converges in training to obtain a target question-answer model. For example, the target question-answer model may be configured to generate question-answer service results from service questions.

During a particular iteration of training an initial question-answer model, terminal device 10a may first obtain input training sample 1 from a training sample set corresponding to a first stage, adjust model parameters of the initial question-answer model using input training sample 1, then obtain input training sample 2 from a training sample set corresponding to a second stage, adjust the model parameters of the initial question-answer model using input training sample 2, and then obtain input training sample 3 from a training sample set corresponding to a third stage, adjust the model parameters of the initial question-answer model using input training sample 3, thereby realizing sequential adjustment of the model parameters of the initial question-answer model using the input training samples obtained sequentially.

The course learning-based fine-tuning algorithm proposed in the embodiments of the present disclosure can improve the generalization capability of the target question-answer model and achieve a better dialog experience. Based on these improved capabilities, product experiences in the following different fields can be significantly enhanced:
1. Customer Service: The target question-answer model may be configured to create a chatting robot. The chatting robot may understand and answer customers' questions, process refund and return requests, provide product information, and the like. In addition, the chatting robot may be configured for telephone services to automatically answer calls and handle simple requests.
2. Content Creation: The target question-answer model may generate various types of content, including blog posts, news reports, social media posts, and the like. The target question-answer model may generate content based on given topics or keywords, and also provide writing suggestions, such as offering different expressions for sentences or proposing possible story lines.
3. Education: The target question-answer model may be configured to create personalized learning resources, for example, generating practice questions according to students' learning progress and comprehension levels. The target question-answer model may alternatively be applied to on-line tutoring to understand and answer students' questions, providing detailed explanations and feedback.
4. Translation and Language Learning: The target question-answer model may be configured for real-time translation, understanding and translating text in various languages. The target question-answer model may alternatively be configured for language learning by offering grammar and pronunciation guidance, helping learners understand and use new languages.
5. Health Consultation: The target question-answer model may be configured to provide basic health and medical consultations, such as explaining symptoms, offering healthy lifestyle advice, and answering questions about medications. However, this cannot replace professional medical advice but serves as a supplementary resource.
6. Personal Assistants: The target question-answer model may be configured to build intelligent personal assistants that understand and answer various questions, such as checking the weather, setting reminders, and managing schedules. The target question-answer model may alternatively be configured to transmit emails and messages, conduct on-line shopping, and the like.
7. Gaming: The target question-answer model may be configured to create richer and more in-depth gaming experiences. For example, the target question-answer model may generate a dialog, drive a non-player character (NPC), and create complex story lines. In addition, the target question-answer model may understand and respond to player inputs, providing a dynamic gaming experience.

The course learning-based training data orchestration method proposed in the embodiments of the present disclosure is adopted for supervised fine-tuning of an LLM. Compared with data splicing modes that do not use course learning, the LLM trained by the present disclosure is improved in evaluations across five dimensions: NLP basic capabilities, multi-turn dialog capabilities, domain application capabilities, reasoning capabilities, and text generation capabilities. Reasoning and multi-turn dialog capabilities are relatively significantly improved, with an effect increase of more than 10%.

In the embodiments of the present disclosure, category division is performed on question-answer pair data through a question-answer pair category information set, to obtain category labels corresponding to the question-answer pair data. Then training sample sets and sample set category labels respectively corresponding to the training sample sets are generated through the question-answer pair data and the category labels respectively corresponding to the question-answer pair data. The number of training samples can be improved, and the diversity of the training samples can be increased. By sorting the training sample sets according to the learning difficulties, the model may learn features of training samples with lower difficulty during training, and then perform training through the training samples with higher difficulty, to gradually help the model learn complex features, thereby achieving the same accuracy as using the entire training sample sequence, avoiding over-fitting on high-difficulty training samples, generalizing more complex and diverse question-answer scenarios, and improving the efficiency of model training and the accuracy of the model.

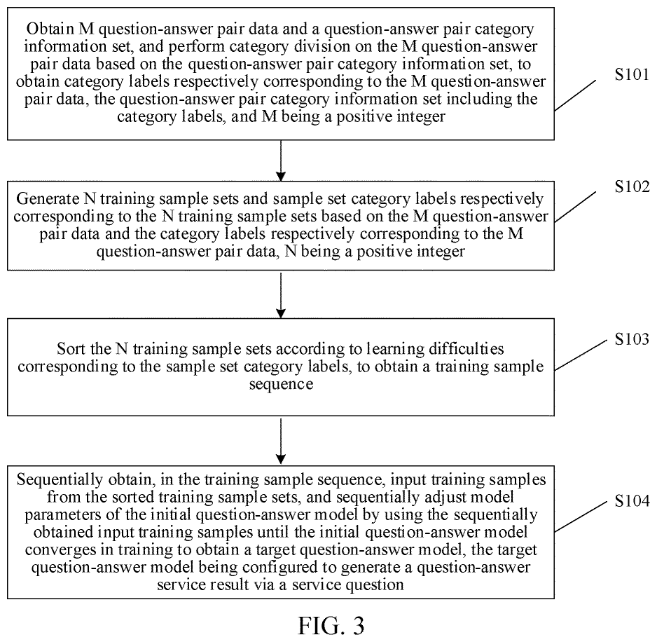

Refer to FIG. 3. FIG. 3 is a schematic flowchart 1 of a data processing method according to an embodiment of the present disclosure. The data processing method may be performed by a computer device. The computer device may be a model server integrating the service server 100 and terminal device 10a as shown in FIG. 1. The following is described by way of example with the computer device performing the data processing method. The data processing method may include at least the following operations S101 to S104:

Operation S101: Obtain M question-answer pair data and a question-answer pair category information set, and perform category division on the M question-answer pair data based on the question-answer pair category information set, to obtain category labels respectively corresponding to the M question-answer pair data, the question-answer pair category information set including the category labels, and M being a positive integer.

Specifically, the computer device may obtain question-answer pair data and a question-answer pair category information set.

The question-answer pair data may be text data for training a large language model, including a series of questions and corresponding answers. The question-answer pair data may be obtained by manual annotation or automatic extraction, and may cover different domains and topics.

The question-answer pair category information set may be an information set for annotating the question-answer pair data, and may be divided into a plurality of category labels. The category labels may be divided according to dimensions such as learning difficulties of questions and answers, a domain (e.g., a copy generation domain or a professional discipline domain) and a topic of a question, an answer type (e.g., a logical reasoning type or a progressive thought type), and a length (e.g., a single-turn answer or a multi-turn answer).

The computer device may perform category division on question-answer pair data through a question-answer pair category information set, to obtain category labels corresponding to the question-answer pair data.

For example, “{question-answer pair data 1, question-answer pair data 2, . . . , question-answer pair data N}” may be classified into the most associated category labels by using the foregoing question-answer pair category information set. The division result may be {“question-answer pair data 1”: NLP basic category label, “question-answer pair data 2”: copy generation category label, . . . , “question-answer pair data N”: multi-turn dialog category label}.

The category labels corresponding to the question-answer pair data may include NLP basic category labels, copy generation category labels, domain-specific category labels, logical reasoning category labels, progressive chain-of-thought category labels, and multi-turn dialog category labels.

The text data of the NLP basic question-answer pair data may be conventional dialogs such as translation tasks, text summarization, text rewriting, and part-of-speech tagging. The NLP basic question-answer pair data focuses on covering text data in which results may be judged with objective measurement metrics. For example, the NLP basic question-answer pair data may be in the text form: “Question: Classify a specified text. Please classify the following sentence as positive, negative, or neutral: This film is very good. Answer: This film is very good, positive.”

The text data of the copy generation question-answer pair data may be generation-type dialogs including comment writing, press release writing, brainstorming, and the like. The copy generation question-answer pair data is configured for covering open-ended text data (the quality of answers may vary with different evaluators). For example, the copy generation question-answer pair data may be in the text form: “Question: I want to write a one-sentence review for a favorite science fiction novel. How would you suggest writing it? Book title: Science Fiction Novel A; Author: Author A. Answer: Science Fiction Novel A by Author A presents an astonishing cosmic epic with its unique science fiction concepts, space time-spanning world view, and magnificent imagination.”

The domain-specific question-answer pair data may be dialogs involving keywords in various professional fields such as law, medicine, and physics. For example, the domain-specific question-answer pair data may be in the text form: “Question: Please identify a diuretic drug from the following drugs: A. Amoxicillin; B. Dexamethasone; C. Furosemide; D. Aspirin. Answer: The diuretic drug is: C. Furosemide.”

The text data of the logical reasoning question-answer pair data may be reasoning-type dialogs such as sorting and comparison, comprehensive analysis, and paradox problems. For example, the logical reasoning question-answer pair data may be in the text form: “Question: A unit organizes staff quality development training, which employees may voluntarily register for. Lao Zhang meets a new employee Xiao Li and talks about this. Lao Zhang reminds Xiao Li: ‘The unit is organizing quality development training. Go register quickly.’ Xiao Li says: ‘I haven't finished my work at hand, so I won't register.’ Which of the following, except one, may be an assumption contained in Xiao Li's answer? A. If the work is finished, then one registers for the quality development training. B. As long as I have not finished my work, I do not need to participate in the quality development training. C. Everyone who registers for the quality development training has finished their work. D. Only those who have finished their work may register for the quality development training. Answer: First, we analyze Xiao Li's answer: ‘I haven't finished my work at hand, so I won't register.’ Next, we analyze the relationship between each option and Xiao Li's answer. Xiao Li reaches the conclusion ‘won't register’ based on the premise ‘work not finished.’ To make this conclusion valid, a relationship connecting ‘not finished’ and ‘won't register’ is required, and ‘not finished’ leads to ‘won't register.’ Options B, C, and D may all be expressed as: ‘If work is not finished, then do not register.’ These options can all serve as bridging premises. Since the question asks for the exception, BCD are excluded. Option A may be expressed as: ‘one won't register since work is not finished.’ The bridging direction herein is opposite. Thus, option A is not a premise of Xiao Li's answer. According to the question, the correct answer is A.”

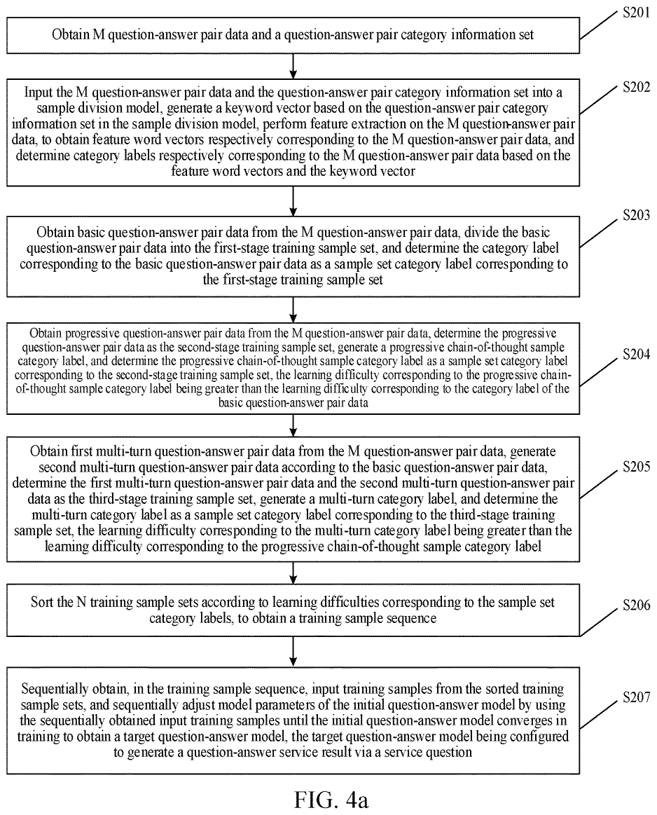

For the content regarding progressive chain-of-thought question-answer pair data and multi-turn dialog question-answer pair data, refer to the detailed description of operations S203 to S205 corresponding to the embodiment in FIG. 4a below.

The text data in the question-answer pair data may cover a plurality of domains or topics in an overlapping manner, and there may be a plurality of associated category labels. When the computer device performs category division on the question-answer pair data, the question-answer pair data may be classified into D most associated category labels. The D category labels may be three category labels, or the question-answer pair data may be classified into a category label if the degree of association between the question-answer pair data and the category label is greater than a preset threshold. This is not limited in the embodiments of the present disclosure.

Operation S102: Generate N training sample sets and sample set category labels respectively corresponding to the N training sample sets based on the M question-answer pair data and the category labels respectively corresponding to the M question-answer pair data, N being a positive integer.

Specifically, the computer device may generate training sample sets and sample set category labels respectively corresponding to the training sample sets based on the question-answer pair data and the category labels respectively corresponding to the question-answer pair data. Each input training sample in each training sample set is associated with at least one piece of question-answer pair data among the M question-answer pair data.

The computer device may determine single-turn question-answer pair data of a basic domain or topic (text data with one question and one answer per dialog turn) as basic question-answer pair data. The basic domain or topic may include NLP basic dialogs, copy generation dialogs, domain-specific dialogs, and logical reasoning dialogs. This is not limited in the embodiments of the present disclosure.

The computer device may divide the basic question-answer pair data into a first-stage training sample set. To be specific, input training samples (also referred to as training samples) in the first-stage training sample set are the basic question-answer pair data. Sample set category labels corresponding to the first-stage training sample set are generated through category labels of the basic question-answer pair data. The category labels of the basic question-answer pair data may be the same as the sample set category labels. Question-answer pair data in which the number of dialog turns is lower than a preset threshold may alternatively be divided into the first-stage training sample set. For example, a training sample set corresponding to short multi-turn dialogs with dialog turns less than or equal to 8 turns may be divided into the first-stage training sample set. The first-stage training sample set may include a training sample set of NLP basic samples, a training sample set of copy generation samples, a training sample set of domain-specific samples, a training sample set of short multi-turn dialogs, and a training sample set of logical reasoning samples.

The computer device may obtain progressive question-answer pair data from the basic question-answer pair samples. For example, data formatting may be performed on the basic question-answer pair data, and the progressive question-answer pair data may be obtained by gradually decomposing answer operations in the basic question-answer pair data into a plurality of operation turns. The computer device may determine the progressive question-answer pair data as a second-stage training sample set. To be specific, input training samples (also referred to as training samples) in the second-stage training sample set are the progressive question-answer pair data obtained by correspondingly processing the basic question-answer pair data. Sample set category labels corresponding to the second-stage training sample set are then directly generated. Therefore, all input training samples in the second-stage training sample set have the sample set category labels.

The computer device may obtain first multi-turn question-answer pair data from the question-answer pair data (e.g., question-answer pair data in the form of original multi-turn dialogs). The computer device may perform data processing on the basic question-answer pair data through an evolutionary algorithm, such as data splicing and data rewriting on the basic question-answer pair data, to obtain second multi-turn question-answer pair data. The computer device may determine the first multi-turn question-answer pair data and the second multi-turn question-answer pair data as a third-stage training sample set. To be specific, input training samples (also referred to as training samples) in the third-stage training sample set are the directly obtained first multi-turn question-answer pair data and the second multi-turn question-answer pair data obtained by correspondingly processing the basic question-answer pair data. Sample set category labels corresponding to the third-stage training sample set are then directly generated. Therefore, all input training samples in the third-stage training sample set have the sample set category labels.

Operation S103: Sort the N training sample sets according to learning difficulties corresponding to the sample set category labels, to obtain a training sample sequence.

Specifically, the computer device may sort the training sample sets according to learning difficulties corresponding to the sample set category labels in ascending order of the learning difficulties, to obtain a training sample sequence. The training sample sequence may include a plurality of training sample sets. The sorting order may be {first-stage training sample set, second-stage training sample set, third-stage training sample set}. The learning difficulty may alternatively be understood as a difficulty for an initial question-answer model to learn the input training samples with the sample set category labels. If the initial question-answer model has difficulty learning the question-answer intention and logic of the input training samples corresponding to a particular type of sample set category labels, the learning difficulty of such input training samples is high. To be specific, the learning difficulty of such sample set category labels is high.

The learning difficulty may be determined based on factors such as the complexity of the data composition of the training samples, the magnitude of a loss value generated during training, an answer error rate, as well as the data volume, diversity, and quality of the training samples. For example, for a training sample set in which sample set category labels are multi-turn dialog category labels, the input training samples contained therein are all complex data belonging to multi-turn dialogs. To be specific, the complexity of data composition is high. Therefore, it may be determined that the learning difficulty of such a training sample set is high. For another example, for a training sample set in which sample set category labels are NLP basic category labels, a loss value generated during training on the input training samples contained therein is generally small and a predicted answer error rate is low, indicating that the learning difficulty of such a training sample set is low.

Within the training sample set of each stage, the computer device may alternatively sort the training sample sets according to the learning difficulties corresponding to the sample set category labels. For example, in the first-stage training sample set, the sorting order may be {training sample set of NLP basic samples, training sample set of copy generation samples, training sample set of domain-specific samples, training sample set of short multi-turn dialog samples, training sample set of logical reasoning samples}.

Operation S104: Sequentially obtain, in the training sample sequence, input training samples from the sorted training sample sets, and sequentially adjust model parameters of the initial question-answer model by using the sequentially obtained input training samples until the initial question-answer model converges in training to obtain a target question-answer model, the target question-answer model being configured to generate a question-answer service result via a service question.

Specifically, the computer device may sequentially obtain, in the training sample sequence, input training samples from the sorted training sample sets, and sequentially adjust model parameters of the initial question-answer model by using the sequentially obtained input training samples.

For example, the training sample sequence may be used as an input data set for one epoch (training period) of training the initial question-answer model. The training sample sets corresponding to each stage in the training sample sequence may be one batch (training batch) for training the initial question-answer model. One epoch may refer to a process in which the training sample sequence is inputted into the initial question-answer model to complete one forward computation and back-propagation. One epoch may alternatively be referred to as one iterative training.

In one epoch, the computer device may sequentially obtain input training samples from the first-stage training sample set, the second-stage training sample set, and the third-stage training sample set. For example, the computer device may obtain input training sample 1 from the first-stage training sample set, and adjust the model parameters of the initial question-answer model by using input training sample 1, to complete one training batch of training the initial question-answer model. Then, the computer device may obtain input training sample 2 from the second-stage training sample set, and adjust the model parameters of the initial question-answer model by using input training sample 2. Next, the computer device may obtain input training sample 3 from the third-stage training sample set, and adjust the model parameters of the initial question-answer model by using input training sample 3, to complete one training period of training the initial question-answer model.

If the initial question-answer model satisfies a convergence condition indicated by model evaluation metrics in the current training period (iterative training), the converged initial question-answer model may be determined as the target question-answer model. The target question-answer model may be configured to generate question-answer service results from service questions. The target question-answer model may alternatively be used as a general question-answer model fine-tuned by the training sample sequence. Subsequently, the general question-answer model may be trained by question-answer texts of a specific domain or topic, so that the trained question-answer model may generate better question-answer service results for service questions of the specific domain or topic.

The convergence condition indicated by the model evaluation metrics may be a performance measure of the model, such as accuracy, precision, recall, precision-recall, etc. This is not limited in the present disclosure.

In the embodiments of the present disclosure, category division is performed on question-answer pair data through a question-answer pair category information set, to obtain category labels corresponding to the question-answer pair data. Then training sample sets and sample set category labels respectively corresponding to the training sample sets are generated through the question-answer pair data and the category labels respectively corresponding to the question-answer pair data. Since the training sample set may contain input training samples obtained by expanding the question-answer pair data, the number of training samples can be increased, and the diversity of the training samples can be improved. By sorting the training sample sets according to the learning difficulties, the model may learn features of training samples with lower difficulty during training, and then perform training through the training samples with higher difficulty, to gradually help the model learn complex features, thereby avoiding over-fitting on high-difficulty training samples, generalizing more complex and diverse question-answer scenarios, and improving the efficiency of model training and the accuracy of the model.

Refer to FIG. 4a. FIG. 4a is a schematic flowchart 2 of a data processing method according to an embodiment of the present disclosure. The data processing method may be performed by a computer device. The computer device may be a model server integrating the service server 100 and terminal device 10a as shown in FIG. 1. The following is described by way of example with the computer device performing the data processing method. The data processing method may include at least the following operations S201 to S207:

Operation S201: Obtain M question-answer pair data and a question-answer pair category information set.

For details, refer to the specific content of operation S101 corresponding to the embodiment of FIG. 3. Detailed description will be omitted herein in the embodiments of the present disclosure.

Operation S202: Input the M question-answer pair data and the question-answer pair category information set into a sample division model, generate a keyword vector based on the question-answer pair category information set in the sample division model, perform feature extraction on the M question-answer pair data, to obtain feature word vectors respectively corresponding to the M question-answer pair data, and determine the category labels respectively corresponding to the M question-answer pair data based on the feature word vectors and the keyword vector.

Specifically, the computer device may input the question-answer pair data and the question-answer pair category information set into a sample division model.

The sample division model may be a converged LLM, which may take the question-answer pair category information set as a text prompt for the question-answer pair data, and perform category division on the question-answer pair data to obtain the corresponding category labels.

A keyword vector may be generated based on the question-answer pair category information set in the sample division model, and feature extraction is performed on the question-answer pair data, to obtain feature word vectors respectively corresponding to the question-answer pair data.

The process of performing, by the computer device, feature extraction on the question-answer pair data may be: filtering service stop words from the M question-answer pair data, and performing text division on the filtered M question-answer pair data, to obtain P question-answer text segments, P being a positive integer greater than or equal to M; and performing part-of-speech tagging on the P question-answer text segments respectively, to obtain P question-answer part-of-speech information, and generating the feature word vectors respectively corresponding to the M question-answer pair data based on the P question-answer text segments and the P question-answer part-of-speech information.

Specifically, the computer device may filter service stop words from the question-answer pair data. The service stop words refer to words or punctuation marks that are common in natural language texts but have no specific meaning in semantic analysis. For example, in Chinese texts, the service stop words may include: “ [symbol] ”,“ [symbol] ”,“ [symbol] ”,“ [symbol] ”,“ [symbol] ”, etc. In English texts, the service stop words may include: “the”, “a”, “an”, “in”, etc.

The computer device may perform text division (also referred to as word segmentation) on the training text set with the service stop words removed. Text division may be implemented by rule matching or probability matching to obtain several question-answer text segments corresponding to the respective question-answer pair data.

The computer device may perform part-of-speech tagging on the question-answer text segments to obtain question-answer part-of-speech information corresponding to the question-answer text segments. Part-of-speech tagging refers to grammatical part-of-speech classification of the question-answer text segments, for example, classification into nouns, verbs, adjectives, adverbs, auxiliary words, and other parts of speech. Part-of-speech tagging enables better understanding of the grammatical structure and semantic information of sentences, thereby improving the accuracy and efficiency of natural language processing tasks. Part-of-speech tagging methods may include rule-based methods, statistical methods, deep learning-based methods, etc. This is not limited in the embodiments of the present disclosure.

The computer device generates a feature word vector of the question-answer pair data based on the question-answer text segments and the question-answer part-of-speech information corresponding to the question-answer text segments. The computer device may determine the category labels respectively corresponding to the question-answer pair data through a matching degree between the feature word vector and the keyword vector.

Operation S203: Obtain basic question-answer pair data from the M question-answer pair data, divide the basic question-answer pair data into the first-stage training sample set, and determine the category label corresponding to the basic question-answer pair data as a sample set category label corresponding to the first-stage training sample set.

Specifically, the computer device may determine single-turn question-answer pair data of a basic domain or topic (text data with one question and one answer per dialog turn) as basic question-answer pair data. The basic domain or topic may include NLP basic dialogs, copy generation dialogs, domain-specific dialogs, and logical reasoning dialogs. This is not limited in the embodiments of the present disclosure.

The computer device may divide the basic question-answer pair data into the first-stage training sample set, and generate the sample set category label corresponding to the first-stage training sample set through the category label corresponding to the basic question-answer pair data.

In some embodiments, the process of also dividing, by the computer device, short dialog question-answer pair data into the first-stage training sample set may specifically include: obtaining context information corresponding to the basic question-answer pair data, the context information being configured for indicating a semantic degree of association among the basic question-answer pair data; and splicing S mutually associated basic question-answer pair data into a short dialog training sample according to the context information, adding the short dialog training sample to the short dialog training sample set, and determining a short dialog label as a sample set category label corresponding to the short dialog training sample set, S being a positive integer.

Specifically, the context information may be configured for indicating a semantic degree of association among the basic question-answer pair data, and may be text content about the text and tasks needing to be known by the model (for example, in a sentiment analysis task, the text content may be a series of sentences with sentiment labels, such as “This product works very well” and “This product is terrible”, etc.), context relations (for example, in a named entity recognition task, the context relations may be relations between entities in the text, such as keywords, place names, or time), semantic information (for example, in a part-of-speech tagging task, the semantic information may be the part of speech of each vocabulary item), and other related information.

The computer device may splice a plurality of mutually associated basic question-answer pair data into short dialog training samples by using the context information. The short dialog training samples may be question-answer pair data with dialog turns less than or equal to 8 turns, where one question and one answer constitute one turn.

A short dialog training sample may be: “Question 1: What is Actor C's zodiac sign? Answer 1: Actor C is Libra. Question 2: You're amazing! You know so much. Answer 2:I also know that Actor C won the Best Actress at the Asian Film Awards! Question 3: Actor C is my idol, and her acting skills are superb. Answer 3: She was truly born for performing arts, and she also won the Best Actress at the Chinese Film Media Awards. Question 4: I really like the films she acts in. Answer 4: I recommend you watch The Equation of Love and Death starring Actor C. In this film, Actor C delivered a highly devoted and sincere performance, drawing the audience into that scenario of ‘love even if I die’, evoking many feelings about the city, love, and gains and losses. Question 5: How is the reputation of this film? Answer 5: Overall, the film has a good reputation. Film C has a score of 8.1 out of 10, with more than 370,000 reviews. Many audiences think the film has a compact plot, sincere emotions, and successful character building, especially Actor C's performance which has been highly praised. Meanwhile, the film's focus on real life and exploration of human nature have also been well-received. Nevertheless, some audiences think the plot is somewhat too bizarre or the ending is slightly abrupt. In general, Film C is a film worth watching. Question 6: Then I'll go watch it now. Answer 6: Okay.”

The computer device may add the short dialog training sample to the short dialog training sample set, determine a short dialog label as a sample set category label corresponding to the short dialog training sample set, and divide the short dialog training sample set into the first-stage training sample set.

The first-stage training sample set may include a training sample set of NLP basic samples, a training sample set of copy generation samples, a training sample set of domain-specific samples, a training sample set of short multi-turn dialogs, and a training sample set of logical reasoning samples.

Operation S204: Obtain progressive question-answer pair data from the M question-answer pair data, determine the progressive question-answer pair data as the second-stage training sample set, generate a progressive chain-of-thought sample category label, and determine the progressive chain-of-thought sample category label as a sample set category label corresponding to the second-stage training sample set, the learning difficulty corresponding to the progressive chain-of-thought sample category label being greater than the learning difficulty corresponding to the category label of the basic question-answer pair data.

Specifically, the computer device obtains progressive question-answer pair data from the basic question-answer pair samples. For example, data formatting may be performed on the basic question-answer pair data, and the progressive question-answer pair data may be obtained by gradually decomposing answer operations in the basic question-answer pair data into a plurality of operation turns.

For example, question-answer pair data B may be: “Question: Xiaoming's family has 10 chicken legs. He wants to distribute them to 3 people. How many chicken legs does each person get? How many chicken legs are left? Answer: We need to find a number such that 10 chicken legs can be evenly distributed to 3 people. Dividing 10 chicken legs by 3 people gives 10/3=3 with a remainder of 1. Therefore, each person can get 3 chicken legs. Finally, 1 chicken leg remains. The answer is 3 chicken legs per person and 1 chicken leg left.” The computer device may gradually decompose the operations of the question-answer pair data B into a plurality of operation turns to obtain decomposed operations. The decomposed operations may be: “Question 1: Xiaoming's family has 10 chicken legs. He wants to distribute them to 3 people. How many chicken legs does each person get? How many chicken legs are left? Answer 1: Operation 1: We need to find a number such that 10 chicken legs can be evenly distributed to 3 people. Question 2: Xiaoming's family has 10 chicken legs. He wants to distribute them to 3 people. How many chicken legs does each person get? How many chicken legs are left? Answer 2: Operation 1: We need to find a number such that 10 chicken legs can be evenly distributed to 3 people. Operation 2: Dividing 10 chicken legs by 3 people gives 10/3=3 with a remainder of 1. Question 3: Xiaoming's family has 10 chicken legs. He wants to distribute them to 3 people. How many chicken legs does each person get? How many chicken legs are left? Answer 3: Operation 1: We need to find a number such that 10 chicken legs can be evenly distributed to 3 people. Operation 2: Dividing 10 chicken legs by 3 people gives 10/3=3 with a remainder of 1. Operation 3: Therefore, each person can get 3 chicken legs. Question 4: Xiaoming's family has 10 chicken legs. He wants to distribute them to 3 people. How many chicken legs does each person get? How many chicken legs are left? Answer 4: Operation 1: We need to find a number such that 10 chicken legs can be evenly distributed to 3 people. Operation 2: Dividing 10 chicken legs by 3 people gives 10/3=3 with a remainder of 1. Operation 3: Therefore, each person can get 3 chicken legs. Operation 4: Finally, 1 chicken leg remains. The answer is 3 chicken legs per person and 1 chicken leg left.”

The decomposed operations may include 4 question-answer turns. The computer device may ignore Question 2, Question 3, and Question 4, and determine Question 1, Answer 1, Answer 2, Answer 3, and Answer 4 as progressive question-answer pair data B. The specific operation decomposition mode may adopt Stepwise formatting. This is not limited in the embodiments of the present disclosure.

The computer device may determine the progressive question-answer pair data as a second-stage training sample set (the second-stage training sample set may include progressive chain-of-thought samples), generate a progressive chain-of-thought sample category label, and determine a sample set category label corresponding to the second-stage training sample set as the progressive chain-of-thought sample category label.

In answers of the progressive question-answer pair data, a plurality of conditions in the questions need to be analyzed, and derivation is gradually performed in the answers to improve accuracy. In view of this, progressive chain-of-thought samples containing a series of intermediate reasoning operations are obtained. Compared with using a single calculation-type answer, this form has clearer logic, and the templated and standardized responses can also stimulate the thinking mode of the model when encountering such problems, i.e., how to flexibly apply massive prior knowledge and integrate information to answer questions accurately.

Operation S205: Obtain first multi-turn question-answer pair data from the M question-answer pair data, generate second multi-turn question-answer pair data according to the basic question-answer pair data, determine the first multi-turn question-answer pair data and the second multi-turn question-answer pair data as the third-stage training sample set, generate a multi-turn category label, and determine the multi-turn category label as a sample set category label corresponding to the third-stage training sample set, the learning difficulty corresponding to the multi-turn category label being greater than the learning difficulty corresponding to the progressive chain-of-thought sample category label.

Specifically, the computer device may obtain first multi-turn question-answer pair data from the question-answer pair data. The first multi-turn question-answer pair data may be question-answer pair data in which the number of dialog turns of original question-answer pair data is greater than 8.

The process of generating, by the computer device, second multi-turn question-answer pair data according to the basic question-answer pair data may be: splicing the basic question-answer pair data to obtain spliced multi-turn question-answer pair data; performing data reconstruction on the basic question-answer pair data to obtain reconstructed multi-turn question-answer pair data; and determining the spliced multi-turn question-answer pair data and the reconstructed multi-turn question-answer pair data as the second multi-turn question-answer pair data.

Specifically, the computer device may perform data processing on the basic question-answer pair data by using an evolutionary algorithm. For example, the computer device may perform data splicing and data rewriting on the basic question-answer pair data to obtain second multi-turn question-answer pair data.

The process of performing, by the computer device, data splicing on the basic question-answer pair data may be: obtaining context information corresponding to H basic question-answer pair data, the context information being configured for indicating a semantic degree of association among the H basic question-answer pair data; obtaining Q basic question-answer pair data according to the context information, and splicing the Q basic question-answer pair data into follow-up dialog data, Q being a positive integer less than or equal to H, and a semantic degree of association among the Q basic question-answer pair data being greater than a first degree-of-association threshold; obtaining T basic question-answer pair data according to the context information, and splicing the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and determining the follow-up dialog data and the random dialog data as the spliced multi-turn question-answer pair data.

Specifically, the computer device may obtain Q basic question-answer pair data through the context information, and splice the Q basic question-answer pair data into follow-up dialog data. Herein, Q is a positive integer less than or equal to H, and Q may be a positive integer greater than 8. The semantic degree of association among the Q basic question-answer pair data is greater than a first degree-of-association threshold. The first degree-of-association threshold may indicate that the question-answer pair data have the same attention keywords. To be specific, topics between two turns of dialogs are related. For example, the computer device may splice 14 basic question-answer pair data into one piece of follow-up dialog data through the context information, and the number of dialog turns of the follow-up dialog data may be 14.

For example, the follow-up dialog data may be: “Question 1: From now on, you need to play Role E all the time. I hope you can act like him. I hope you answer and reply in Role E's tone, manner, and vocabulary. Do not write any explanations, just answer like Role E. You are required to know all knowledge about Role E. After that, you are required to follow the character, preferences, speaking style, and language of the role you play to answer. Where did you first meet Harry Potter and Ron Weasley? Answer 1: I first met Role E on the train, and then the three of us became friends. Question 2: How did you view Role E in that situation at that time? Answer 2: When I first met Role E, I admit I was full of curiosity about him. After all, his name was already well-known. However, seeing him and understanding him are two different things. I did not take a fancy to him immediately. In fact, I thought he might be an arrogant man at first, but after I got to know him, I realized that Role E was a brave, selfless, and kind friend. Every adventure he undertook was to protect the people he loved. He did not take advantage of his fame. Instead, he hoped to have a peaceful life. Thus, I gradually began to respect and appreciate Role E. Question 3: As your friend, what personalities of Role E do you particularly like? Answer 3: I am always impressed by Role E's determination and courage. He never gives up no matter what difficulties he faces. He is loyal, upright, and always willing to do the right thing for others. (10 turns of dialogs omitted in the middle) Question 14: Who are you? Answer 14: I am Role E.”

The computer device may obtain T basic question-answer pair data through the context information, and splice the T basic question-answer pair data into random dialog data.

Herein, T is a positive integer less than or equal to H, and T may be greater than 8. The semantic degree of association among the T basic question-answer pair data is less than a second degree-of-association threshold, and the first degree-of-association threshold is greater than or equal to the second degree-of-association threshold. To be specific, the semantic degree of association of the basic question-answer pair data required for splicing in the follow-up dialog data is higher than that of the basic question-answer pair data required in the random dialog data. In the random dialog data, the computer device may control the types of spliced sample content to become gradually diverse and gradually increase the dialog length. The basic question-answer pair data may be dialogs of the same type with a relatively large topic jump degree. In this process, consecutive basic question-answer pair data of the same type may alternatively be randomly spliced, to improve the anti-interference capability of model dialogs.

For example, the computer device may splice 12 basic question-answer pair data into one piece of random dialog data through the context information, and the number of dialog turns of the random dialog data may be 12.

The random dialog data may be: “Question 1: Please arrange the following actions in the correct order: open the door, take off shoes, hang up the coat, wash hands. Answer 1: The order may vary from person to person, but usually it may be as follows: 1. Open the door; 2. Take off shoes; 3. Hang up the coat; 4. Wash hands. Question 2: What is a dynamic proxy? What are its applications? Answer 2: The dynamic proxy generates a proxy class dynamically at runtime. Applications of the dynamic proxy include data query, back-ends of testing frameworks, obtaining of Java annotation objects, etc. Question 3: Which has a larger volume, 2 tons of displays or 2 tons of feathers? Answer 3: The density of feathers is lower than that of displays. Therefore, with the same weight, the volume of feathers is larger than that of displays. Thus, 2 tons of feathers have a larger volume. (8 turns of dialogs omitted in the middle) Question 12: Which has a larger volume, seven kilograms of laptops or seven kilograms of toilet paper? Answer 12: The density of toilet paper is lower than that of laptops. Therefore, with the same weight, the volume of toilet paper is larger than that of laptops. Thus, seven kilograms of toilet paper have a larger volume.”

The computer device may determine the follow-up dialog data (also referred to as complex evolution multi-turn samples) and the random dialog data (also referred to as medium evolution multi-turn samples) as spliced multi-turn question-answer pair data, divide the spliced multi-turn question-answer pair data into training samples corresponding to a third stage, set the sample set category label of the follow-up dialog data as a complex evolution sample set category label, and set the sample set category label of the random dialog data as a medium evolution sample set category label.

The process of performing, by the computer device, data reconstruction on the basic question-answer pair data (the number of basic question-answer pair data may be H, H being a positive integer) may be: rewriting, based on evolution constraint information, H basic question-answer pair data into deep evolution data, the evolution constraint information being configured for indicating evolution category labels included in the question-answer pair category information set, and the deep evolution data being associated with the evolution category labels; obtaining context information corresponding to the H basic question-answer pair data, and rewriting mutually associated basic question-answer pair data into breadth evolution data according to the context information, the context information being configured for indicating a semantic degree of association among the H basic question-answer pair data; and determining the deep evolution data and the breadth evolution data as the reconstructed multi-turn question-answer pair data.

Specifically, the computer device may rewrite, based on evolution constraint information, the basic question-answer pair data into deep evolution data.

The evolution constraint information is configured for indicating the evolution category labels included in the question-answer pair category information set. For example, the computer device may perform deep data rewriting on domain-specific question-answer pair data F and copy generation question-answer pair data G to obtain deep evolution data K.

The question-answer pair data F may be: “Question: Please identify a diuretic drug from the following drugs: A. Amoxicillin; B. Dexamethasone; C. Furosemide; D. Aspirin. Answer: The diuretic drug is: C. Furosemide.” The question-answer pair data G may be: “Question: What are the medicinal effects of the diuretic drug? Answer: The diuretic drug has effects such as diuresis, blood pressure reduction, heart failure improvement, and renal insufficiency treatment.”

The deep evolution data K obtained by deep data rewriting may be: “Question 1: What is a diuretic drug? Answer 1: Furosemide. Question 2: What are the medicinal effects of furosemide? Answer 2: Furosemide has effects such as diuresis, blood pressure reduction, heart failure improvement, and renal insufficiency treatment.”

In some embodiments, when the number of dialog turns of the deep evolution data K obtained by data rewriting is less than a dialog turn threshold, the computer device may continue to perform data rewriting on the deep evolution data K. The computer device may rewrite, based on the evolution constraint information, the basic question-answer pair data into transitional evolution data, and continue to perform, if the number of question-answer turns of the transitional evolution data is less than a question-answer turn threshold, data rewriting on the transitional evolution data based on the evolution constraint information until the number of question-answer turns of the rewritten transitional evolution data is greater than or equal to the question-answer turn threshold, to determine the rewritten transitional evolution data as the deep evolution data.

The computer device may obtain context information corresponding to H basic question-answer pair data, and rewrite mutually associated basic question-answer pair data into breadth evolution data by using the context information. For example, breadth data rewriting is performed on the domain-specific question-answer pair data F and the copy generation question-answer pair data G to obtain breadth evolution data L.

The breadth evolution data L obtained by breadth data rewriting may be: “Question 1: What are the medicinal effects of amoxicillin, dexamethasone, furosemide, and aspirin? Answer 1: The medicinal effect of amoxicillin is to treat bacterial infections. Furosemide has medicinal effects such as diuresis, blood pressure reduction, heart failure improvement, and renal insufficiency treatment.”

The computer device may determine the deep evolution data and the breadth evolution data as reconstructed multi-turn question-answer pair data (also referred to as GAtt samples), divide the reconstructed multi-turn question-answer pair data into the third-stage training sample set, and determine a sample set category label of the reconstructed multi-turn question-answer pair data as a GAtt sample set category label.

Breadth evolution aims to enhance topic coverage, skill coverage, and overall dataset diversity of the question-answer pair data. Deep evolution can gradually increase the difficulty and ensure that generated instructions are challenging. The deep evolution data obtained by deep evolution and the breadth evolution data obtained by breadth evolution can optimize model performance and robustness during the training process.

Operation S206: Sort the N training sample sets according to learning difficulties corresponding to the sample set category labels, to obtain a training sample sequence.

Specifically, the computer device may sort the training sample sets according to the learning difficulties corresponding to the sample set category labels, to obtain a training sample sequence. The sorting order of the training sample sequence may be as follows: a first-stage training sample set: {training sample set of NLP basic samples, training sample set of copy generation samples, training sample set of domain-specific samples, training sample set of short multi-turn dialog samples, training sample set of logical reasoning samples}, a second-stage training sample set: {training sample set of progressive chain-of-thought samples}, and a third-stage training sample set: {training sample set of medium evolution multi-turn samples, training sample set of complex evolution multi-turn samples, training sample set of GAtt samples}.

In some embodiments, when the short multi-turn dialog samples are composed of relatively complex question-answer pair data, and the learning difficulty of the short multi-turn dialog samples is higher than that of the logical reasoning samples, a course scheduling mode combining coarse-grained and fine-grained manners may be adopted for the question-answer pair data. Overall, the process may be divided into four-stage course learning. The first stage is conventional single-turn sample learning. The second stage is simple (fewer turns) multi-turn dialog sample learning. The third stage is progressive chain-of-thought sample learning. The fourth stage is complex (more turns) multi-turn dialog sample learning. In the multi-turn dialog field of the second stage and the fourth stage, the difficulty of multi-turn dialog samples may be defined from three dimensions: topic richness, length, and depth. Management is performed from the source of data collection according to the measurement dimensions of multi-turn dialog difficulty.

In the foregoing course scheduling mode combining coarse-grained and fine-grained manners, the three-stage training sample sequence may be further subdivided into four stages. To be specific, the short multi-turn dialog samples in the first stage of the three-stage training sample sequence may be separately used as the second-stage training sample set, and the short multi-turn dialog samples are determined as a training stage after the first stage, to obtain a four-stage training sample sequence. The sorting order of the four-stage training sample sequence may be as follows: a first-stage training sample set: {training sample set of NLP basic samples, training sample set of copy generation samples, training sample set of domain-specific samples, training sample set of logical reasoning samples}, a second-stage training sample set: {training sample set of short multi-turn dialog samples}, a third-stage training sample set: {training sample set of progressive chain-of-thought samples}, and a fourth-stage training sample set: {training sample set of medium evolution multi-turn samples, training sample set of complex evolution multi-turn samples, training sample set of GAtt samples}. In the subsequent iterative training process, the order of obtaining input training samples from the four-stage training sample sequence may be the first-stage training sample set, the second-stage training sample set, the third-stage training sample set, and the fourth-stage training sample set in sequence.

Operation S207: Sequentially obtain, in the training sample sequence, input training samples from the sorted training sample sets, and sequentially adjust model parameters of the initial question-answer model by using the sequentially obtained input training samples until the initial question-answer model converges in training to obtain a target question-answer model, the target question-answer model being configured to generate a question-answer service result via a service question.

Specifically, the computer device may sequentially obtain, in the training sample sequence, input training samples from the sorted training sample sets, and sequentially adjust model parameters of the initial question-answer model by using the sequentially obtained input training samples, so as to perform a plurality of iterative trainings.

For ease of understanding, an i^{th} iterative training is taken as an example. The process of the i^{th} iterative training may be: randomly obtaining, in a j^{th} iterative training, B first input training samples from the training sample set Aᵢ, adjusting the model parameters of the initial question-answer model by using the B first input training samples, continuing to randomly obtain C second input training samples from the training sample set Aᵢ₊₁, and adjusting the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed, B and C being positive integers, and j being a positive integer; determining, if the j^{th} iterative training is completed and the initial question-answer model satisfies a model convergence condition, the initial question-answer model satisfying the model convergence condition as the target question-answer model; and if the j^{th} iterative training is completed and the initial question-answer model does not satisfy the model convergence condition, continuing to sequentially adjust, in a (j+1)^{th} iterative training, the model parameters of the initial question-answer model by using sequentially obtained input training samples via the training sample sequence until the initial question-answer model converges in training to obtain the target question-answer model.

Specifically, the training process of the initial question-answer model may include a plurality of iterative trainings (epoch, also referred to as a training period). Each iterative training may include a plurality of training batches.

In one epoch, the computer device may sequentially obtain input training samples from the first-stage training sample set, the second-stage training sample set, and the third-stage training sample set. For example, the computer device may obtain input training sample 1 from the first-stage training sample set, and adjust the model parameters of the initial question-answer model by using input training sample 1, to complete one training batch of training the initial question-answer model. Then, the computer device may obtain input training sample 2 from the second-stage training sample set, and adjust the model parameters of the initial question-answer model by using input training sample 2. Next, the computer device may obtain input training sample 3 from the third-stage training sample set, and adjust the model parameters of the initial question-answer model by using input training sample 3, to complete one training period of training the initial question-answer model.

For ease of understanding, taking the j^{th} iterative training as an example, the training sample sequence may include a training sample set Aᵢ and a training sample set Aᵢ₊₁, the training sample set Aᵢ preceding the training sample set Aᵢ₊₁ in the training sample sequence.

The computer device may randomly obtain, in a j^{th} iterative training, B first input training samples from the training sample set Aᵢ, adjust the model parameters of the initial question-answer model by using the B first input training samples, continue to randomly obtain C second input training samples from the training sample set Aᵢ₊₁, and adjust the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed.

The training sample set Aᵢ may be a training sample set of NLP basic samples, and the training sample set Aᵢ₊₁ may be a training sample set of copy generation samples. When the initial question-answer model finishes adjusting model parameters by using input training samples in a training sample set of GAtt samples, it is determined that the j^{th} iterative training is completed.

If the j^{th} iterative training is completed and the initial question-answer model satisfies a model convergence condition, the initial question-answer model satisfying the model convergence condition is determined as the target question-answer model. The target question-answer model may be used as a sample division model fine-tuned through the training sample sequence, and may perform category division for model training in specific domains or topics.

The convergence condition indicated by the model evaluation metrics may be a performance measure of the model, such as accuracy, precision, recall, precision-recall, etc. This is not limited in the present disclosure.

If the j^{th} iterative training is completed and the initial question-answer model does not satisfy the model convergence condition, adjusting the model parameters of the initial question-answer model sequentially in the (j+1)^{th} iterative training by using the sequentially obtained input training samples according to the training sample sequence is continued. For example, the input training samples may be successively obtained from the training sample set of NLP basic samples, the training sample set of copy generation samples, . . . , and the training sample set of GAtt samples in the training sample sequence until the initial question-answer model converges in training to obtain the target question-answer model.

Refer to FIG. 4b further. FIG. 4b is a schematic diagram 2 of a data processing scenario according to an embodiment of the present disclosure. As shown in FIG. 4b, the computer device may obtain training samples and perform iterative training on the initial question-answer model until the initial question-answer model satisfies the model convergence condition.

In the i^{th} iterative training, the computer device may randomly obtain first-stage input training samples from the first-stage training sample set according to the training sample sequence, and adjust model parameters of the initial question-answer model by using the first-stage input training samples.

The first-stage training sample set includes a training sample set of NLP basic samples, a training sample set of copy generation samples, a training sample set of domain-specific samples, a training sample set of short multi-turn dialog samples, and a training sample set of logical reasoning samples. The computer device may sequentially randomly obtain input training sample 1 from the training sample set of NLP basic samples and adjust model parameters of the initial question-answer model by using input training sample , then randomly obtain input training sample 2 from the training sample set of copy generation samples and adjust model parameters of the initial question-answer model by using input training sample 2, and finally randomly obtain input training sample 5 from the training sample set of logical reasoning samples and adjust model parameters of the initial question-answer model by using input training sample 5, to complete the model parameter adjustment of the initial question-answer model in the first stage.

Then, according to the training sample sequence, the computer device randomly obtains second-stage input training samples from the second-stage training sample set, and adjusts model parameters of the initial question-answer model by using the second-stage input training samples. Specifically, the computer device may randomly obtain input training sample 6 from the training sample set of progressive chain-of-thought samples and adjust model parameters of the initial question-answer model by using input training sample 6, to complete the model parameter adjustment of the initial question-answer model in the second stage.

Then, according to the training sample sequence, the computer device randomly obtains third-stage input training samples from the third-stage training sample set, and adjusts model parameters of the initial question-answer model by using the third-stage input training samples.

The third-stage training sample set may include a training sample set of medium evolution multi-turn samples, a training sample set of complex evolution multi-turn samples, and a training sample set of GAtt samples. The computer device may sequentially randomly obtain input training sample 7 from the training sample set of medium evolution multi-turn samples and adjust model parameters of the initial question-answer model by using input training sample 7, then randomly obtain input training sample 8 from the training sample set of complex evolution multi-turn samples and adjust model parameters of the initial question-answer model by using input training sample 8, and finally randomly obtain input training sample 9 from the training sample set of GAtt samples and adjust model parameters of the initial question-answer model by using input training sample 9, to complete the model parameter adjustment of the initial question-answer model in the third stage.

When the initial question-answer model completes model parameter adjustment in the first stage, the second stage, and the third stage, it may be determined that the initial question-answer model completes the i^{th} iterative training. The computer device may determine whether the initial question-answer model satisfies the model convergence condition. If not, the (i+1)^{th} iterative training is performed (input training sample 10, input training sample 11, . . . , input training sample 18 may be continuously obtained), new input training samples are re-obtained from the first-stage training sample set according to the training sample sequence, and iterative training is performed on the initial question-answer model until the initial question-answer model satisfies the model convergence condition.

In different iterative trainings, for example, input training sample 1 obtained from the training sample set of NLP basic samples in the i^{th} iterative training and input training sample 10 obtained from the training sample set of NLP basic samples in the (i+1)^{th} iterative training, the order of samples obtained in different iterative trainings may be randomly distributed. For example, input training sample 1 may include training sample A, training sample B, and training sample C. Input training sample 2 may include training sample B, training sample C, and training sample A. Not all samples may be sampled in one iterative training. This is not limited in the embodiments of the present disclosure.

When input training samples are obtained from the training sample sequence in different iterative trainings (training periods), the sorting order of the training sample sets in each training stage of the training sample sequence may be randomly shuffled. For example, the training sample sequence of the i^{th} iterative training may be as follows: a first-stage training sample set: {training sample set of NLP basic samples, training sample set of copy generation samples, training sample set of domain-specific samples, training sample set of logical reasoning samples, training sample set of short multi-turn dialog samples}, a second-stage training sample set: {training sample set of progressive chain-of-thought samples}, and a third-stage training sample set: {training sample set of medium evolution multi-turn samples, training sample set of complex evolution multi-turn samples, training sample set of GAtt samples}. For example, the training sample sequence of the (i+1)^{th} iterative training may be as follows: a first-stage training sample set: {training sample set of logical reasoning samples, training sample set of domain-specific samples, training sample set of copy generation samples, training sample set of NLP basic samples, training sample set of short multi-turn dialog samples}, a second-stage training sample set: {training sample set of progressive chain-of-thought samples}, and a third-stage training sample set: {training sample set of GAtt samples, training sample set of medium evolution multi-turn samples, training sample set of complex evolution multi-turn samples}.

In the embodiments of the present disclosure, category division is performed on question-answer pair data through a question-answer pair category information set, to obtain category labels corresponding to the question-answer pair data. Then training sample sets and sample set category labels respectively corresponding to the training sample sets are generated through the question-answer pair data and the category labels respectively corresponding to the question-answer pair data. Since the training sample set may contain input training samples obtained by expanding the question-answer pair data, the number of training samples can be increased, and the diversity of the training samples can be improved. By sorting the training sample sets according to the learning difficulties, the model may learn features of training samples with lower difficulty during training, and then perform training through the training samples with higher difficulty, to gradually help the model learn complex features, thereby avoiding over-fitting on high-difficulty training samples, generalizing more complex and diverse question-answer scenarios, and improving the efficiency of model training and the accuracy of the model. On the other hand, data splicing and data rewriting can enhance the topic coverage, skill coverage, and overall data set diversity of the question-answer pair data, and optimize model performance and robustness during the training process.

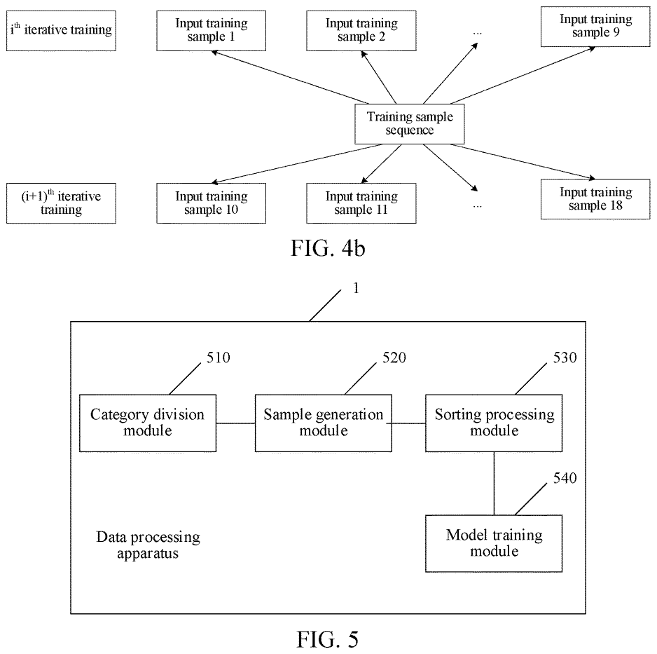

Refer to FIG. 5. FIG. 5 is a schematic structural diagram of a data processing apparatus according to an embodiment of the present disclosure. As shown in FIG. 5, a data processing apparatus 1 includes a category division module 510, a sample generation module 520, a sorting processing module 530, and a model training module 540.

The category division module 510 is configured to obtain M question-answer pair data and a question-answer pair category information set, and perform category division on the M question-answer pair data based on the question-answer pair category information set, to obtain category labels respectively corresponding to the M question-answer pair data. The question-answer pair category information set includes the category labels, and M is a positive integer. The specific functions of the category division module 510 may refer to the detailed description of operation S101 in the embodiment corresponding to FIG. 3, and will not be described in detail herein.

The sample generation module 520 is configured to generate N training sample sets and sample set category labels respectively corresponding to the N training sample sets based on the M question-answer pair data and the category labels respectively corresponding to the M question-answer pair data. N is a positive integer. Input training samples in each training sample set are all associated with at least one piece of question-answer pair data among the M question-answer pair data. The specific functions of the sample generation module 520 may refer to the detailed description of operation S102 in the embodiment corresponding to FIG. 3, and will not be described in detail herein.

The sorting processing module 530 is configured to sort the N training sample sets according to learning difficulties corresponding to the sample set category labels, to obtain a training sample sequence. The specific functions of the sorting processing module 530 may refer to the detailed description of operation S103 in the embodiment corresponding to FIG. 3, and will not be described in detail herein.

The model training module 540 is configured to sequentially obtain, in the training sample sequence, input training samples from the sorted training sample sets, and sequentially adjust model parameters of the initial question-answer model by using the sequentially obtained input training samples, until a target question-answer model is obtained after the initial question-answer model converges in training. The target question-answer model is configured to generate a question-answer service result via a service question. The learning difficulty refers to a difficulty for an initial question-answer model to train and learn the input training samples having the sample set category labels. The specific functions of the model training module 540 may refer to the detailed description of operation S104 in the embodiment corresponding to FIG. 3, and will not be described in detail herein.

In a possible implementation, when performing category division on the M question-answer pair data based on the question-answer pair category information set, to obtain category labels respectively corresponding to the M question-answer pair data, the category division module 510 is specifically configured to perform the following operations:
inputting the M question-answer pair data and the question-answer pair category information set into a sample division model, generating a keyword vector based on the question-answer pair category information set in the sample division model, and performing feature extraction on the M question-answer pair data, to obtain feature word vectors respectively corresponding to the M question-answer pair data; and
determining the category labels respectively corresponding to the M question-answer pair data based on the feature word vectors and the keyword vector.

In a possible implementation, when performing feature extraction on the M question-answer pair data, to obtain feature word vectors respectively corresponding to the M question-answer pair data, the category division module 510 is specifically configured to perform the following operations:
filtering service stop words from the M question-answer pair data, and performing text division on the filtered M question-answer pair data, to obtain P question-answer text segments, P being a positive integer greater than or equal to M; and
performing part-of-speech tagging on the P question-answer text segments respectively, to obtain P question-answer part-of-speech information, and generating the feature word vectors respectively corresponding to the M question-answer pair data based on the P question-answer text segments and the P question-answer part-of-speech information.

In a possible implementation, N training sample sets include a first-stage training sample set, a second-stage training sample set, and a third-stage training sample set. When generating N training sample sets and sample set category labels respectively corresponding to the N training sample sets based on the M question-answer pair data and the category labels respectively corresponding to the M question-answer pair data, the sample generation module 520 is specifically configured to perform the following operations:
obtaining basic question-answer pair data from the M question-answer pair data, dividing the basic question-answer pair data into the first-stage training sample set, and determining the category label corresponding to the basic question-answer pair data as a sample set category label corresponding to the first-stage training sample set;
obtaining progressive question-answer pair data from the M question-answer pair data, determining the progressive question-answer pair data as the second-stage training sample set, generating a progressive chain-of-thought sample category label, and determining the progressive chain-of-thought sample category label as a sample set category label corresponding to the second-stage training sample set, the learning difficulty corresponding to the progressive chain-of-thought sample category label being greater than the learning difficulty corresponding to the category label of the basic question-answer pair data; and
obtaining first multi-turn question-answer pair data from the M question-answer pair data, generating second multi-turn question-answer pair data according to the basic question-answer pair data, determining the first multi-turn question-answer pair data and the second multi-turn question-answer pair data as the third-stage training sample set, generating a multi-turn category label, and determining the multi-turn category label as a sample set category label corresponding to the third-stage training sample set, the learning difficulty corresponding to the multi-turn category label being greater than the learning difficulty corresponding to the progressive chain-of-thought sample category label.

In a possible implementation, the number of the basic question-answer pair data is H, H being a positive integer less than or equal to M. The first-stage training sample set further includes a short dialog training sample set. The sample generation module 520 is further configured to perform the following operations:
obtaining context information corresponding to H basic question-answer pair data, the context information being configured for indicating a semantic degree of association among the H basic question-answer pair data; and
splicing S mutually associated basic question-answer pair data into a short dialog training sample according to the context information, adding the short dialog training sample to the short dialog training sample set, and determining a short dialog label as a sample set category label corresponding to the short dialog training sample set, S being a positive integer less than or equal to H.

In a possible implementation, when generating second multi-turn question-answer pair data according to the basic question-answer pair data, the sample generation module 520 is specifically configured to perform the following operations:
splicing the basic question-answer pair data to obtain spliced multi-turn question-answer pair data;
performing data reconstruction on the basic question-answer pair data to obtain reconstructed multi-turn question-answer pair data; and
determining the spliced multi-turn question-answer pair data and the reconstructed multi-turn question-answer pair data as the second multi-turn question-answer pair data.

In a possible implementation, the number of the basic question-answer pair data is H, H being a positive integer less than or equal to M. When splicing the basic question-answer pair data to obtain spliced multi-turn question-answer pair data, the sample generation module 520 is specifically configured to perform the following operations:
obtaining context information corresponding to H basic question-answer pair data, the context information being configured for indicating a semantic degree of association among the H basic question-answer pair data;
obtaining Q basic question-answer pair data according to the context information, and splicing the Q basic question-answer pair data into follow-up dialog data, Q being a positive integer less than or equal to H, and a semantic degree of association among the Q basic question-answer pair data being greater than a first degree-of-association threshold;
obtaining T basic question-answer pair data according to the context information, and splicing the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and determining the follow-up dialog data and the random dialog data as the spliced multi-turn question-answer pair data.

In a possible implementation, the number of the basic question-answer pair data is H, H being a positive integer less than or equal to M. When performing data reconstruction on the basic question-answer pair data to obtain reconstructed multi-turn question-answer pair data, the sample generation module 520 is specifically configured to perform the following operations:
rewriting, based on evolution constraint information, the basic question-answer pair data into deep evolution data, the evolution constraint information being configured for indicating evolution category labels included in the question-answer pair category information set, and the deep evolution data being associated with the evolution category labels;
obtaining context information corresponding to H basic question-answer pair data, and rewriting mutually associated basic question-answer pair data into breadth evolution data according to the context information, the context information being configured for indicating a semantic degree of association among the H basic question-answer pair data; and determining the deep evolution data and the breadth evolution data as the reconstructed multi-turn question-answer pair data.

In a possible implementation, when rewriting, based on evolution constraint information, the basic question-answer pair data into deep evolution data, the sample generation module 520 is specifically configured to perform the following operations:
rewriting, based on the evolution constraint information, the basic question-answer pair data into transitional evolution data; and
continuing to perform, if the number of question-answer turns of the transitional evolution data is less than a question-answer turn threshold, data rewriting on the transitional evolution data based on the evolution constraint information until the number of question-answer turns of the rewritten transitional evolution data is greater than or equal to the question-answer turn threshold, to determine the rewritten transitional evolution data as the deep evolution data.

In a possible implementation, The training sample sequence includes a training sample set Aᵢ and a training sample set Aᵢ₊₁, the training sample set Aᵢ preceding the training sample set Aᵢ₊₁ in the training sample sequence. When sequentially obtaining, in the training sample sequence, input training samples from the sorted training sample sets, and sequentially adjusting model parameters of the initial question-answer model by using the sequentially obtained input training samples until the initial question-answer model converges in training to obtain a target question-answer model, the model training module 540 is specifically configured to perform the following operations:
randomly obtaining, in a j^{th} iterative training, B first input training samples from the training sample set Aᵢ, adjusting the model parameters of the initial question-answer model by using the B first input training samples, continuing to randomly obtain C second input training samples from the training sample set Aᵢ₊₁, and adjusting the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed, B and C being positive integers, and j being a positive integer;
determining, if the j^{th} iterative training is completed and the initial question-answer model satisfies a model convergence condition, the initial question-answer model satisfying the model convergence condition as the target question-answer model; and
if the j^{th} iterative training is completed and the initial question-answer model does not satisfy the model convergence condition, continuing to sequentially adjust, in a (j+1)^{th} iterative training, the model parameters of the initial question-answer model by using sequentially obtained input training samples via the training sample sequence until the initial question-answer model converges in training to obtain the target question-answer model.

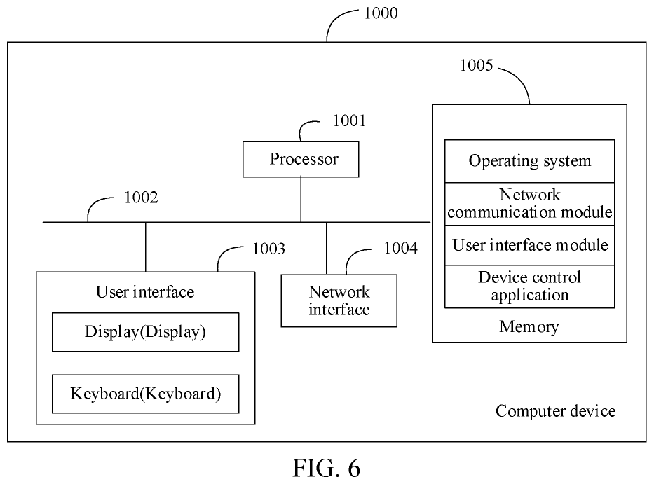

Refer to FIG. 6. FIG. 6 is a schematic structural diagram of a computer device according to an embodiment of the present disclosure. As shown in FIG. 6, a computer device 1000 may include a processor 1001, a network interface 1004, and a memory 1005. Furthermore, the computer device 1000 may further include a user interface 1003 and at least one communication bus 1002. The communication bus 1002 is configured to implement connection and communication between the components. The user interface 1003 may include a display and a keyboard. In some embodiments, the user interface 1003 may further include a standard wired interface and a standard wireless interface. In some embodiments, the network interface 1004 may include a standard wired interface and a wireless interface (e.g., a WI-FI interface). The memory 1005 may be a high-speed RAM, or may be a non-volatile memory, for example, at least one magnetic disk memory. In some embodiments, the memory 1005 may alternatively be at least one storage apparatus away from the foregoing processor 1001. As shown in FIG. 6, the memory 1005 used as a computer-readable storage medium may include an operating system, a network communication module, a user interface module, and a device-control application.

In the computer device 1000 shown in FIG. 6, the network interface 1004 may provide a network communication network element. The user interface 1003 is mainly an interface for providing input for a user. The processor 1001 may be configured to call the device-control application stored in the memory 1005, for:
obtaining M question-answer pair data and a question-answer pair category information set, and performing category division on the M question-answer pair data based on the question-answer pair category information set, to obtain category labels respectively corresponding to the M question-answer pair data, the question-answer pair category information set including the category labels, and M being a positive integer;
generating N training sample sets and sample set category labels respectively corresponding to the N training sample sets based on the M question-answer pair data and the category labels respectively corresponding to the M question-answer pair data, N being a positive integer, and input training samples in each training sample set being all associated with at least one piece of question-answer pair data among the M question-answer pair data; sorting the N training sample sets according to learning difficulties corresponding to the sample set category labels, to obtain a training sample sequence, the learning difficulty referring to a difficulty for an initial question-answer model to train and learn the input training samples having the sample set category labels; and
sequentially obtaining, in the training sample sequence, input training samples from the sorted training sample sets, and sequentially adjusting model parameters of the initial question-answer model by using the sequentially obtained input training samples until the initial question-answer model converges in training to obtain a target question-answer model, the target question-answer model being configured to generate a question-answer service result via a service question.

The computer device 1000 described in the embodiments of the present disclosure may perform the descriptions of the data processing method in the embodiment corresponding to either of FIG. 3 and FIG. 4a. Details are not described herein again. In addition, the description of beneficial effects of the same method are not described herein again.

Furthermore, embodiments of the present disclosure further provide a computer-readable storage medium, and the computer-readable storage medium has a computer program stored therein. When the foregoing processor executes the computer program, the descriptions of the data processing method in the embodiment corresponding to either of FIG. 3 and FIG. 4a can be performed. Therefore, details are not described herein again. In addition, the description of beneficial effects of the same method are not described herein again. For technical details that are not disclosed in the embodiments of the computer-readable storage medium included in the present disclosure, refer to the descriptions about the method embodiments of the present disclosure.

The computer-readable storage medium may be a data processing apparatus provided in any of the foregoing embodiments or an internal storage unit of the computer device, such as a hard disk or an internal memory of the computer device. The computer-readable storage medium may alternatively be an external storage device of the computer device, for example, a removable hard disk drive, a smart media card (SMC), a secure digital (SD) card, or a flash card equipped on the computer device. Further, the computer-readable storage medium may alternatively include both an internal storage unit and an external storage device of the computer device. The computer-readable storage medium is configured to store the computer program and other programs and data that are required by the computer device. The computer-readable storage medium may further be configured to temporarily store data that has been displayed or will be displayed.

Furthermore, an embodiment of the present disclosure further provides a computer program product. The computer program product includes a computer program. The computer program is stored in a computer-readable storage medium. A processor of a computer device reads the computer program from the computer-readable storage medium. The processor executes the computer program, to enable the computer device to perform the method provided in the embodiment corresponding to either of FIG. 3 and FIG. 4a.

The terms “first”, “second”, and the like in the specification, the claims, and the accompanying drawings of the embodiments of the present disclosure are intended to distinguish between different objects, instead of describing a particular sequence. Furthermore, the term “include” and any variation thereof are intended to cover a non-exclusive inclusion. For example, processes, methods, apparatuses, products, or devices including a series of operations or units are not limited to the listed operations or modules, but instead, include operations or modules not listed in some embodiments, or include other operations or units inherent in these processes, methods, apparatuses, products, or devices in some embodiments.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to network elements. Whether the network elements are executed in a mode of hardware or software depends on particular applications and design constraint conditions of the technical solutions. A person skilled in the art may use different methods to implement the described network elements for each particular application, but it is not to be considered that the implementation goes beyond the scope of the present disclosure.

The methods and related apparatuses provided in the embodiments of the present disclosure are described with reference to the method flowcharts and/or schematic structural diagrams provided in the embodiments of the present disclosure. Specifically, each flow and/or block in the method flowcharts and/or schematic structural diagrams and a combination of flows and/or blocks in the flowcharts and/or block diagrams may be implemented according to computer program instructions. These computer program instructions may be provided to a processor of a general-purpose computer, a special-purpose computer, an embedded processing machine, or another programmable federated learning device to generate a machine, so that instructions executed by a processor of the computer or the another programmable federated learning device generate an apparatus for implementing functions specified in one or more processes of the flowcharts and/or one or more blocks of the schematic structural diagrams. These computer program instructions may alternatively be stored in a computer-readable memory that can direct a computer or another programmable federated learning device to operate in a specific manner, so that the instructions stored in the computer-readable memory produce a product including an instruction apparatus. The instruction apparatus implements the functions specified in one or more processes of the flowchart and/or one or more blocks of the schematic structural diagram. These computer program instructions may alternatively be loaded onto a computer or another programmable application display device, so that a series of operations are performed on the computer or the another programmable device, thereby generating computer-implemented processing. Therefore, the instructions executed on the computer or the another programmable device provide operations for implementing a specific function in one or more processes in the flowcharts and/or in one or more blocks in the schematic structural diagram.

The operations of the methods in the embodiments of the present disclosure may be adjusted in terms of a sequence, combined, and deleted based on an actual requirement.

The modules of the apparatuses of the embodiments of the present disclosure may be combined, divided, or deleted according to an actual requirement.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method, comprising:
obtaining M question-answer pair data and a question-answer pair category information set;
performing category division on the M question-answer pair data based on the question-answer pair category information set, to obtain category labels respectively corresponding to the M question-answer pair data, the question-answer pair category information set comprising the category labels, M being a positive integer;
generating N training sample sets and sample set category labels respectively corresponding to the N training sample sets based on the M question-answer pair data and the category labels respectively corresponding to the M question-answer pair data, N being a positive integer, and input training samples in each of the N training sample sets being associated with at least one piece of question-answer pair data among the M question-answer pair data;
sorting the N training sample sets according to a learning difficulty corresponding to the sample set category labels, to obtain a training sample sequence, the learning difficulty corresponding to a sample set category label referring to a difficulty for the initial question-answer model to learn input training samples having the sample set category label; and
sequentially obtaining, in the training sample sequence, input training samples and sequentially adjusting model parameters of the initial question-answer model by using the input training samples until the initial question-answer model converges in training to obtain a target question-answer model, the target question-answer model being used to generate a question-answer service result based on a service question.

2. The method according to claim 1, wherein performing category division on the M question-answer pair data based on the question-answer pair category information set, to obtain the category labels respectively corresponding to the M question-answer pair data comprises:
inputting the M question-answer pair data and the question-answer pair category information set into a sample division model;
generating a keyword vector based on the question-answer pair category information set in the sample division model;
performing feature extraction on the M question-answer pair data, to obtain feature word vectors respectively corresponding to the M question-answer pair data; and
determining the category labels respectively corresponding to the M question-answer pair data based on the feature word vectors and the keyword vector.

3. The method according to claim 2, wherein performing feature extraction on the M question-answer pair data, to obtain the feature word vectors respectively corresponding to the M question-answer pair data comprises:
filtering service stop words from the M question-answer pair data, and performing text division on the M question-answer pair data, to obtain P question-answer text segments, P being a positive integer greater than or equal to M;
performing part-of-speech tagging on the P question-answer text segments respectively, to obtain P question-answer part-of-speech information; and
generating the feature word vectors respectively corresponding to the M question-answer pair data based on the P question-answer text segments and the P question-answer part-of-speech information.

4. The method according to claim 1, wherein the N training sample sets comprise a first-stage training sample set, a second-stage training sample set, and a third-stage training sample set;
and wherein generating N training sample sets and sample set category labels respectively corresponding to the N training sample sets based on the M question-answer pair data and the category labels respectively corresponding to the M question-answer pair data comprises:
obtaining basic question-answer pair data from the M question-answer pair data, dividing the basic question-answer pair data into the first-stage training sample set, and determining the category label corresponding to the basic question-answer pair data as a sample set category label corresponding to the first-stage training sample set;
obtaining progressive question-answer pair data from the M question-answer pair data, determining the progressive question-answer pair data as the second-stage training sample set, generating a progressive chain-of-thought sample category label, and determining the progressive chain-of-thought sample category label as a sample set category label corresponding to the second-stage training sample set, wherein a learning difficulty corresponding to the progressive chain-of-thought sample category label is greater than a learning difficulty corresponding to the category label of the basic question-answer pair data; and
obtaining first multi-turn question-answer pair data from the M question-answer pair data, generating second multi-turn question-answer pair data according to the basic question-answer pair data, determining the first multi-turn question-answer pair data and the second multi-turn question-answer pair data as the third-stage training sample set, generating a multi-turn category label, and determining the multi-turn category label as a sample set category label corresponding to the third-stage training sample set, wherein a learning difficulty corresponding to the multi-turn category label is greater than the learning difficulty corresponding to the progressive chain-of-thought sample category label.

5. The method according to claim 4, wherein a number of the basic question-answer pair data is H, H being a positive integer less than or equal to M, the first-stage training sample set further comprises a short dialog training sample set, and the method further comprises:
obtaining context information corresponding to H basic question-answer pair data, wherein the context information indicates a semantic degree of association among the H basic question-answer pair data; and
splicing S mutually associated basic question-answer pair data into a short dialog training sample according to the context information, adding the short dialog training sample to the short dialog training sample set, and determining a short dialog label as a sample set category label corresponding to the short dialog training sample set, S being a positive integer less than or equal to H.

6. The method according to claim 4, wherein generating the second multi-turn question-answer pair data according to the basic question-answer pair data comprises:
splicing the basic question-answer pair data to obtain spliced multi-turn question-answer pair data;
performing data reconstruction on the basic question-answer pair data to obtain reconstructed multi-turn question-answer pair data; and
determining the spliced multi-turn question-answer pair data and the reconstructed multi-turn question-answer pair data as the second multi-turn question-answer pair data.

7. The method according to claim 6, wherein a number of the basic question-answer pair data is H, H being a positive integer less than or equal to M, and wherein splicing the basic question-answer pair data to obtain the spliced multi-turn question-answer pair data comprises:
obtaining context information corresponding to H basic question-answer pair data, wherein the context information indicates a semantic degree of association among the H basic question-answer pair data;
obtaining Q basic question-answer pair data according to the context information, and splicing the Q basic question-answer pair data into follow-up dialog data, Q being a positive integer less than or equal to H, and a semantic degree of association among the Q basic question-answer pair data being greater than a first degree-of-association threshold;
obtaining T basic question-answer pair data according to the context information, and splicing the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and
determining the follow-up dialog data and the random dialog data as the spliced multi-turn question-answer pair data.

8. The method according to claim 6, wherein a number of the basic question-answer pair data is H, H being a positive integer less than or equal to M, and wherein performing data reconstruction on the basic question-answer pair data to obtain the reconstructed multi-turn question-answer pair data comprises:
rewriting, based on evolution constraint information, the basic question-answer pair data into deep evolution data, wherein the evolution constraint information indicates evolution category labels comprised in the question-answer pair category information set and the deep evolution data is associated with the evolution category labels;
obtaining context information corresponding to H basic question-answer pair data, and rewriting mutually associated basic question-answer pair data into breadth evolution data according to the context information, wherein the context information indicates a semantic degree of association among the H basic question-answer pair data; and
determining the deep evolution data and the breadth evolution data as the reconstructed multi-turn question-answer pair data.

9. The method according to claim 8, wherein rewriting, based on the evolution constraint information, the basic question-answer pair data into the deep evolution data comprises:
rewriting, based on the evolution constraint information, the basic question-answer pair data into transitional evolution data; and
continuing to perform, when a number of question-answer turns of the transitional evolution data is less than a question-answer turn threshold, data rewriting on the transitional evolution data based on the evolution constraint information until the number of question-answer turns of the transitional evolution data is greater than or equal to the question-answer turn threshold, to determine the transitional evolution data as the deep evolution data.

10. The method according to claim 1, wherein the training sample sequence comprises a training sample set Aᵢ and a training sample set Aᵢ₊₁, the training sample set Aᵢ preceding the training sample set Aᵢ₊₁ in the training sample sequence;
and wherein sequentially obtaining, in the training sample sequence, the input training samples, and sequentially adjusting the model parameters of the initial question-answer model by using the input training samples until the initial question-answer model converges in training to obtain the target question-answer model comprises:
randomly obtaining, in a j^{th} iterative training, B first input training samples from the training sample set Aᵢ, adjusting the model parameters of the initial question-answer model by using the B first input training samples, continuing to randomly obtain C second input training samples from the training sample set Aᵢ₊₁, and adjusting the model parameters of the initial question-answer model by using the C second input training samples until the adjustment of the model parameters of the initial question-answer model by using input training samples in an N^{th} training sample set in the training sample sequence is completed, to determine that the j^{th} iterative training is completed, B and C being positive integers, j being a positive integer;
determining, when the j^{th} iterative training is completed and the initial question-answer model satisfies a model convergence condition, the initial question-answer model satisfying the model convergence condition as the target question-answer model; and
when the j^{th} iterative training is completed and the initial question-answer model does not satisfy the model convergence condition, continuing to sequentially adjust, in a (j+1)^{th} iterative training, the model parameters of the initial question-answer model by using the input training samples based on the training sample sequence until the initial question-answer model converges in training to obtain the target question-answer model.

11. A data processing apparatus, comprising a memory for storing instructions and a processor for executing the instructions to:
obtain M question-answer pair data and a question-answer pair category information set;
perform category division on the M question-answer pair data based on the question-answer pair category information set, to obtain category labels respectively corresponding to the M question-answer pair data, the question-answer pair category information set comprising the category labels, M being a positive integer;
generate N training sample sets and sample set category labels respectively corresponding to the N training sample sets based on the M question-answer pair data and the category labels respectively corresponding to the M question-answer pair data, N being a positive integer, input training samples in each training sample set being associated with at least one piece of question-answer pair data among the M question-answer pair data;
sort the N training sample sets according to a learning difficulty corresponding to the sample set category labels, to obtain a training sample sequence, the learning difficulty corresponding to a sample set category label referring to a difficulty for the initial question-answer model to learn input training samples having the sample set category label; and
sequentially obtain, in the training sample sequence, input training samples, and sequentially adjust model parameters of the initial question-answer model by using the input training samples until the initial question-answer model converges in training to obtain a target question-answer model, the target question-answer model being used to generate a question-answer service result based on a service question.

12. The data processing apparatus according to claim 11, wherein the processor, when being configured to perform category division on the M question-answer pair data based on the question-answer pair category information set, to obtain the category labels respectively corresponding to the M question-answer pair data, is configured to execute the instructions to:
input the M question-answer pair data and the question-answer pair category information set into a sample division model;
generate a keyword vector based on the question-answer pair category information set in the sample division model;
perform feature extraction on the M question-answer pair data, to obtain feature word vectors respectively corresponding to the M question-answer pair data; and
determine the category labels respectively corresponding to the M question-answer pair data based on the feature word vectors and the keyword vector.

13. The data processing apparatus according to claim 12, wherein the processor, when being configured to perform feature extraction on the M question-answer pair data, to obtain the feature word vectors respectively corresponding to the M question-answer pair data, is configured to execute the instructions to:
filter service stop words from the M question-answer pair data, and perform text division on the M question-answer pair data, to obtain P question-answer text segments, P being a positive integer greater than or equal to M;
perform part-of-speech tagging on the P question-answer text segments respectively, to obtain P question-answer part-of-speech information; and
generate the feature word vectors respectively corresponding to the M question-answer pair data based on the P question-answer text segments and the P question-answer part-of-speech information.

14. The data processing apparatus according to claim 11, wherein the N training sample sets comprise a first-stage training sample set, a second-stage training sample set, and a third-stage training sample set;
and wherein the processor, when being configured to generate N training sample sets and sample set category labels respectively corresponding to the N training sample sets based on the M question-answer pair data and the category labels respectively corresponding to the M question-answer pair data, is configured to execute the instructions to:
obtain basic question-answer pair data from the M question-answer pair data, divide the basic question-answer pair data into the first-stage training sample set, and determine the category label corresponding to the basic question-answer pair data as a sample set category label corresponding to the first-stage training sample set;
obtain progressive question-answer pair data from the M question-answer pair data, determine the progressive question-answer pair data as the second-stage training sample set, generate a progressive chain-of-thought sample category label, and determine the progressive chain-of-thought sample category label as a sample set category label corresponding to the second-stage training sample set, wherein a learning difficulty corresponding to the progressive chain-of-thought sample category label is greater than a learning difficulty corresponding to the category label of the basic question-answer pair data; and
obtain first multi-turn question-answer pair data from the M question-answer pair data, generate second multi-turn question-answer pair data according to the basic question-answer pair data, determine the first multi-turn question-answer pair data and the second multi-turn question-answer pair data as the third-stage training sample set, generate a multi-turn category label, and determine the multi-turn category label as a sample set category label corresponding to the third-stage training sample set, wherein a learning difficulty corresponding to the multi-turn category label is greater than the learning difficulty corresponding to the progressive chain-of-thought sample category label.

15. The data processing apparatus according to claim 14, wherein a number of the basic question-answer pair data is H, H being a positive integer less than or equal to M, the first-stage training sample set further comprises a short dialog training sample set, and the processor is further configured to execute the instructions to:
obtain context information corresponding to H basic question-answer pair data, wherein the context information indicates a semantic degree of association among the H basic question-answer pair data; and
splice S mutually associated basic question-answer pair data into a short dialog training sample according to the context information, add the short dialog training sample to the short dialog training sample set, and determine a short dialog label as a sample set category label corresponding to the short dialog training sample set, S being a positive integer less than or equal to H.

16. The data processing apparatus according to claim 14, wherein the processor, when being configured to generate the second multi-turn question-answer pair data according to the basic question-answer pair data, is configured to execute the instructions to:
splice the basic question-answer pair data to obtain spliced multi-turn question-answer pair data;
perform data reconstruction on the basic question-answer pair data to obtain reconstructed multi-turn question-answer pair data; and
determine the spliced multi-turn question-answer pair data and the reconstructed multi-turn question-answer pair data as the second multi-turn question-answer pair data.

17. The data processing apparatus according to claim 16, wherein a number of the basic question-answer pair data is H, H being a positive integer less than or equal to M, and wherein the processor, when being configured to splice the basic question-answer pair data to obtain the spliced multi-turn question-answer pair data, is configured to execute the instructions to:
obtain context information corresponding to H basic question-answer pair data, wherein the context information indicates a semantic degree of association among the H basic question-answer pair data;
obtain Q basic question-answer pair data according to the context information, and splice the Q basic question-answer pair data into follow-up dialog data, Q being a positive integer less than or equal to H, and a semantic degree of association among the Q basic question-answer pair data being greater than a first degree-of-association threshold;
obtain T basic question-answer pair data according to the context information, and splice the T basic question-answer pair data into random dialog data, T being a positive integer less than or equal to H, a semantic degree of association among the T basic question-answer pair data being less than a second degree-of-association threshold, and the first degree-of-association threshold being greater than or equal to the second degree-of-association threshold; and
determine the follow-up dialog data and the random dialog data as the spliced multi-turn question-answer pair data.

18. The data processing apparatus according to claim 16, wherein a number of the basic question-answer pair data is H, H being a positive integer less than or equal to M, and wherein the processor, when being configured to perform data reconstruction on the basic question-answer pair data to obtain the reconstructed multi-turn question-answer pair data, is configured to execute the instructions to:
rewrite, based on evolution constraint information, the basic question-answer pair data into deep evolution data, wherein the evolution constraint information indicates evolution category labels comprised in the question-answer pair category information set and the deep evolution data is associated with the evolution category labels;
obtain context information corresponding to H basic question-answer pair data, and rewrite mutually associated basic question-answer pair data into breadth evolution data according to the context information, wherein the context information indicates a semantic degree of association among the H basic question-answer pair data; and
determine the deep evolution data and the breadth evolution data as the reconstructed multi-turn question-answer pair data.

19. The data processing apparatus according to claim 18, wherein the processor, when being configured to rewrite, based on the evolution constraint information, the basic question-answer pair data into the deep evolution dat, is configured to execute the instructions to:
rewrite, based on the evolution constraint information, the basic question-answer pair data into transitional evolution data; and
continue to perform, when a number of question-answer turns of the transitional evolution data is less than a question-answer turn threshold, data rewriting on the transitional evolution data based on the evolution constraint information until the number of question-answer turns of the transitional evolution data is greater than or equal to the question-answer turn threshold, to determine the transitional evolution data as the deep evolution data.

20. A non-transitory computer readable medium storing a plurality of instructions, wherein the plurality of instructions, when executed by a processor, configure the instructions to:
obtain M question-answer pair data and a question-answer pair category information set;
perform category division on the M question-answer pair data based on the question-answer pair category information set, to obtain category labels respectively corresponding to the M question-answer pair data, the question-answer pair category information set comprising the category labels, M being a positive integer;
generate N training sample sets and sample set category labels respectively corresponding to the N training sample sets based on the M question-answer pair data and the category labels respectively corresponding to the M question-answer pair data, N being a positive integer, input training samples in each training sample set being associated with at least one piece of question-answer pair data among the M question-answer pair data;
sort the N training sample sets according to a learning difficulty corresponding to the sample set category labels, to obtain a training sample sequence, the learning difficulty corresponding to a sample set category label referring to a difficulty for the initial question-answer model to learn input training samples having the sample set category label; and
sequentially obtain, in the training sample sequence, input training sample, and sequentially adjusting model parameters of the initial question-answer model by using the input training samples until the initial question-answer model converges in training to obtain a target question-answer model, the target question-answer model being used to generate a question-answer service result based on a service question.
